(19) United States
(12) Patent Application Publication
(10) Pub. No.: US 2023/0007517 A1
(43) Pub. Date: Jan. 5, 2023

(54) STATE TRANSITION FEEDBACK

(71) Applicant: QUALCOMM Incorporated, San Diego, CA (US)

(72) Inventors: Xiaojie WANG, Hillsborough, NJ (US); Xiaoxia ZHANG, San Diego, CA (US); Junyi LI, Fairless Hills, PA (US)

(21) Appl. No.: 17/367,213

(22) Filed: Jul. 2, 2021

(51) Int. Cl. H04W 24/08; H04W 24/10

(52) U.S. Cl. CPC H04W 24/08; H04W 24/10

(57) ABSTRACT

Method and apparatus for signaling enabling a state transition of a transmission mode. The apparatus measures at least one reference signal from a serving TRP to determine a link quality between the UE and the serving TRP. The apparatus transmits feedback including a state transition indication if the link quality between the UE and the serving TRP falls below a threshold. The feedback enables a state transition of a transmission mode.

### TECHNICAL FIELD

The present disclosure relates generally to communication systems, and more particularly, to a configuration for signaling enabling a state transition of a transmission mode.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus measures at least one reference signal from a serving transmission reception point (TRP) to determine a link quality between the UE and the serving TRP. The apparatus transmits feedback including a state transition indication if the link quality between the UE and the serving TRP falls below a threshold, wherein the feedback enables a state transition of a transmission mode.

In an aspect of the disclosure, a method, a computer-readable medium, and an apparatus are provided. The apparatus may be a device at a UE. The device may be a processor and/or a modem at a UE or the UE itself. The apparatus transmits, to a transmission reception point (TRP) associated with a base station, at least one reference signal. The apparatus receives, from the TRP associated with the base station, a state transition indication if a link quality between the UE and the TRP serving the UE falls below a threshold, wherein the state transition indication enables a state transition of a transmission mode

In an aspect of the disclosure, a method, a computer-readable medium, and an apparatus are provided. The apparatus may be a device at a base station. The device may be a processor and/or a modem at a base station or the base station itself. The apparatus transmits, via a transmission reception point (TRP) associated with the base station, at least one reference signal to a user equipment (UE). The apparatus receives, from the UE, feedback including a state transition indication if a link quality between the UE and the TRP serving the UE falls below a threshold, wherein the feedback enables a state transition of a transmission mode.

In an aspect of the disclosure, a method, a computer-readable medium, and an apparatus are provided. The apparatus may be a device at a base station. The device may be a processor and/or a modem at a base station or the base station itself. The apparatus measures at least one reference signal, received from a user equipment (UE), to determine a link quality between the UE and a serving transmission reception point (TRP). The apparatus transmits, to the UE via the serving TRP, a state transition indication if the link quality between the UE and the serving TRP falls below a threshold, wherein the state transition indication enables a state transition of a transmission mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates example aspects of a sidelink slot structure.

FIG. 5 is a diagram illustrating an example of a multi-TRP system.

FIG. 6 is a diagram illustrating an example of a multi-TRP system.

FIG. 7 is a diagram illustrating an example of an industrial IoT device in a multi-TRP system.

FIG. 8 is a diagram illustrating an example of an industrial IoT device in a sidelink communication system.

FIG. 9A is a diagram illustrating an example of transmission mode states of a UE.

FIG. 9B is a diagram illustrating an example of transmission mode states of a UE.

FIG. 10A is a diagram illustrating an example of transmission mode states of a UE.

FIG. 10B is a diagram illustrating an example of transmission mode states of a UE.

FIG. 11 is a diagram illustrating an example of transmission mode states of a UE.

FIG. 12 is a diagram illustrating an example of transmission mode states of a UE.

FIG. 13 is a call flow diagram of signaling between a UE, a TRP, and another UE or TRP.

FIG. 14 is a call flow diagram of signaling between a UE, a TRP, and another UE or TRP.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

In industrial IoT (IIoT), sidelink may enable direct programmable logical controller (PLC) and sensors/actuators (S/A) communications. A wireless PLC is desirable for flexible and simple deployment. A wireless PLC may be configured to control a plurality of S/As, and may have strict latency requirements (e.g., within 1 ms) and a reliability requirement of 10⁻⁶ error rate. IIoT devices may experience challenges in RF environments due to blockage of communication signals from nearby machinery.

Multiple TRPs utilized together may for an mTRP system, which may be deployed in an effort to enhance data transfer. A single TRP may be used in instances where the link between the TRP and the IIoT device is consistently good, e.g., consistently meeting particular latency and/or quality levels. However, in instances where the link between the TRP and the IIoT device becomes degraded or unreliable, a switch may be made to provide a different link that is more reliable. In some instances, waiting for the IIoT device to transmit an indication of a degradation of link quality (e.g., NAK) may be inefficient due to latency requirements for IIoT.

A UE (e.g., PLC) may have one or more sidelinks to allow for multi-path diversity. If a sidelink is blocked or not reliable, another sidelink, or a Uu link, may be utilized to ensure added reliability. Similarly, if a Uu link is blocked, one or more sidelinks may be used to provide transmit diversity. Path switching between sidelink and Uu assists in improving reliability and latency of wireless communication. Multi-path diversity may allow for joint sidelink and Uu operation to provide a high reliability. However, such reliability may be at the expense of an increase in power consumption. switching between transmission modes may be based on the channel state information (CSI) of a link. Efficient and accurate switching may be referred to as seamless switching in some aspects. For example, a single TRP or sidelink may be sufficient (e.g., meet quality, reliability, etc. thresholds) in some instances. The base station may switch a transmission state to mTRP or joint sidelink and Uu operation in instances where the link has degraded or has fallen below a threshold. The change in the link quality may be indicated via a CSI measurement and feedback.

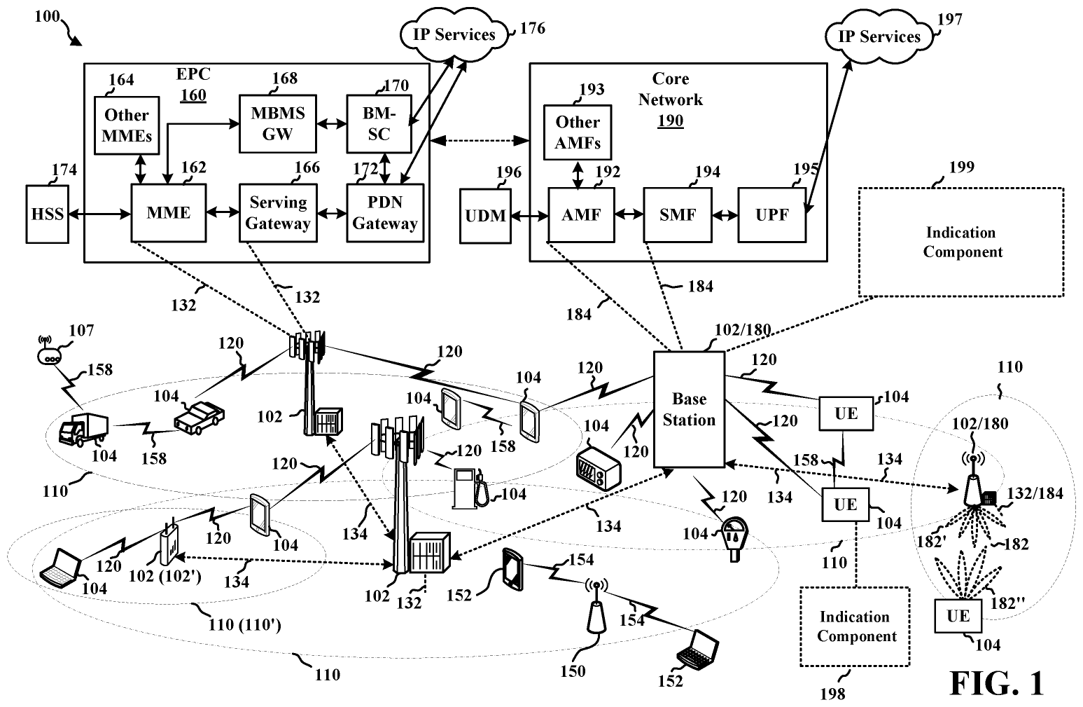

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

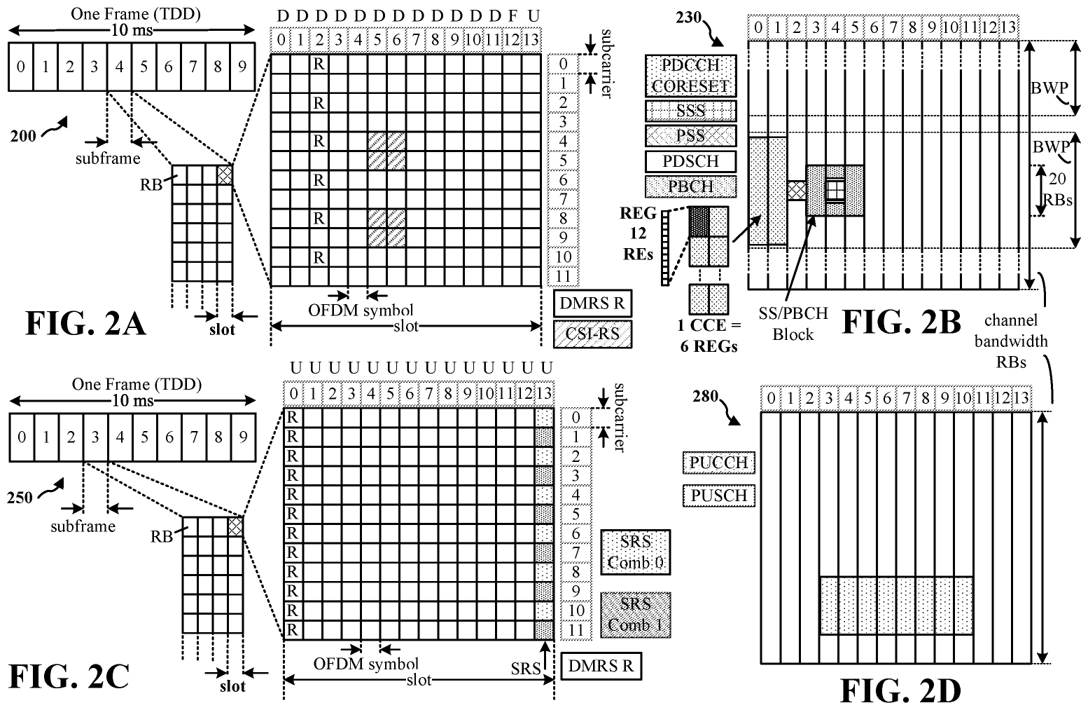

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, the UE 104 may be configured to switch between transmission modes based on a link quality between the UE and a serving TRP. For example, the UE 104 may comprise an indication component 198 configured to switch between transmission modes based on a link quality between the UE and a serving TRP. The UE 104 may measure at least one reference signal from a serving TRP to determine a link quality between the UE and the serving TRP. The UE 104 may transmit feedback including a state transition indication if the link quality between the UE and the serving TRP falls below a threshold, wherein the feedback enables a state transition of a transmission mode.

Referring again to FIG. 1, in certain aspects, the base station 180 may be configured to switch between transmission modes based on a link quality between a UE and a serving TRP. For example, the base station 180 may comprise an indication component 199 configured to switch between transmission modes based on a link quality between a UE and a serving TRP. The base station 180 may transmit, via a TRP associated with the base station, at least one reference signal to a UE. The base station 180 may receive, from the UE, feedback including a state transition indication if a link quality between the UE and the TRP serving the UE falls below a threshold, wherein the feedback signal enables a state transition of a transmission mode.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 600, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (610 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ* 15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

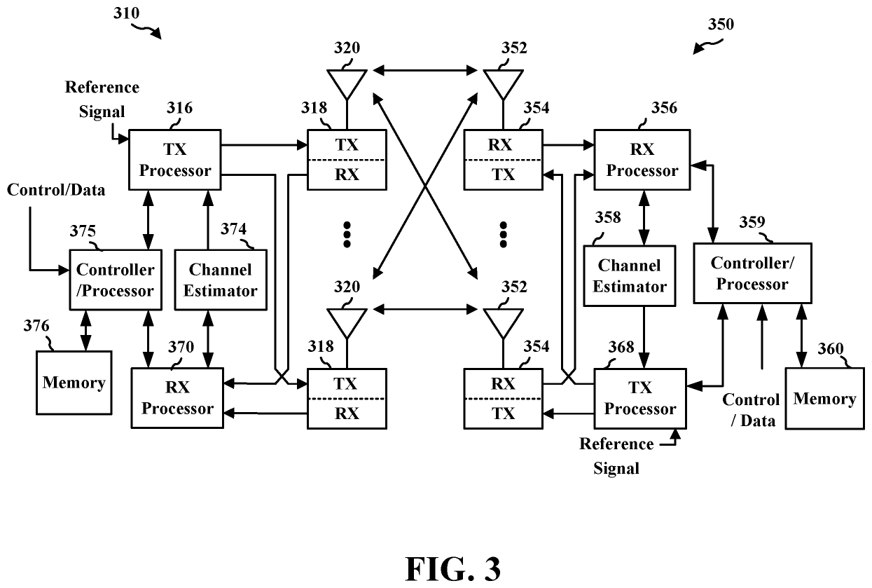

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

FIG. 3 is a block diagram 300 of a first wireless communication device 310 in communication with a second wireless communication device 350 based on sidelink. In some examples, the devices 310 and 350 may communicate based on sidelink, such as V2X, or other D2D communication. In some examples, the wireless communication may be based on Uu. For example, the device 310 may be a base station, and the device 350 may be a UE. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

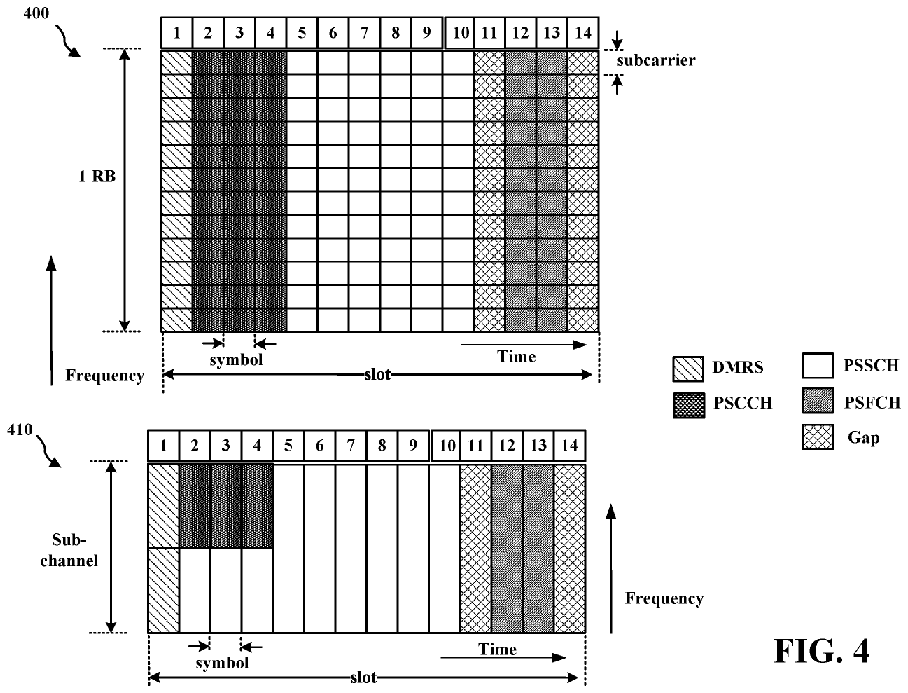

FIG. 4 includes diagrams 400 and 410 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), which may be referred to as SCI-1, and the PSSCH may include a second portion of SCI (which may be referred to as SCI-2) in some examples.

SCI may comprise SCI 1-A in PSCCH. SCI 1-A may comprise a priority of 3 bits. For frequency resource assignment, the bits may depend on the number of slot reservation and the number of subchannels. The time resource assignment may comprise 5 or 9 bits for 2 or 3 reservations. The resource reservation period may comprise bits based on the number of allowed periods. The DMRS pattern may comprise bits based on the number of configured patterns. The format of SCI 2 may comprise 2 bits. A beta offset rate matching for SCI 2 may comprise 2 bits. A DMRS port may comprise 1 bit indicating one or two data layers. In some aspects, the MCS may comprise 5 bits, while additional MCS table may comprise 0-2 bits. The PSFCH overhead indicator may comprise 0 or 1 bit. The SCI 1-A in the PSCCH may be decoded by intended receivers and/or other sidelink UEs to allow for channel sensing and avoid or minimize resource collision.

SCI 2 in PSSCH may be front-loaded. For example, a HARQ identifier may comprise bits based on the number of HARQ processes. The NDI may comprise 1 bit, while the RV-ID may comprise 2 bits. The source identifier may comprise 8 bits, while the destination identifier may comprise 16 bits. HARQ may be enabled or disabled based on a bit. SCI 2 may comprise SCI 2-A only fields, such as cast type (e.g., broadcast, groupcast, unicast) based on 2 bits, or CSI request based on 1 bit. SCI 2 may comprise SCI 2-B only fields (e.g., NACK only groupcast) comprising a zone identifier comprised of 12 bits, or a communication range comprised of 4 bits. SCI 2 may be intended for receivers for decoding PSSCH.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 4. Multiple slots may be aggregated together in some aspects.

A UE (e.g., such as UE 104 in FIG. 1) may transmit a sidelink transmission, e.g., comprising a control channel (e.g., PSCCH) and/or a corresponding data channel (e.g., PSSCH), that may be received by one or more other UEs (e.g., such as one or more UEs 104 in FIG. 1). A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs may each be capable of sidelink transmission in addition to sidelink reception. The sidelink transmissions may be unicast, broadcast or multicast to nearby devices. For example, a UE may transmit sidelink communication intended for receipt by other UEs within a range of the transmitting UE. Additionally/alternatively, an RSU 107 may transmit or receive sidelink communication from with a UE.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

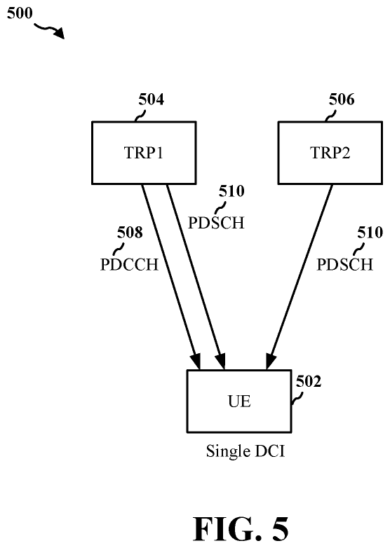

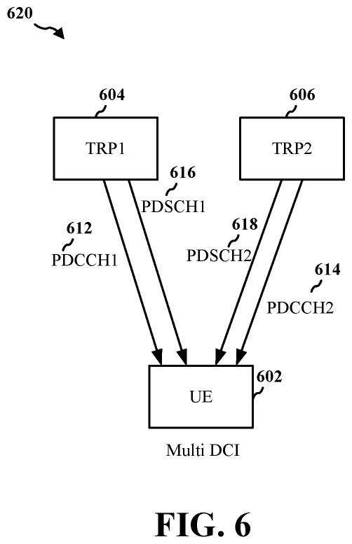

FIGS. 5 and 6 are examples 500, 620 are examples of mTRP systems. The example 500 of FIG. 5 includes a UE 502, a TRP1504, and a TRP2 506. The TRP1 504 may transmit a PDCCH 508 to the UE 502 as well as a PDSCH 510. The TRP2 506 may transmit a PDSCH 510 to the UE 502. The example 620 of FIG. 6 includes the UE 602, the TRP1 604, and the TRP2 606, but the system of FIG. 6 is a multi-DCI based mTRP transmission system, comprising a joint HARQ or a separate HARQ. The example 500 of FIG. 5 shows a single DCI based mTRP transmission, where the same MCS is used, and each PDSCH 510 may correspond to a set of layers. An advantage of mTRP systems is that such systems may increase the overall transmission power at multiple transmission points, as well as increasing the overall rank of the transmission, which may allow mTRP systems to offer reliability against blocking.

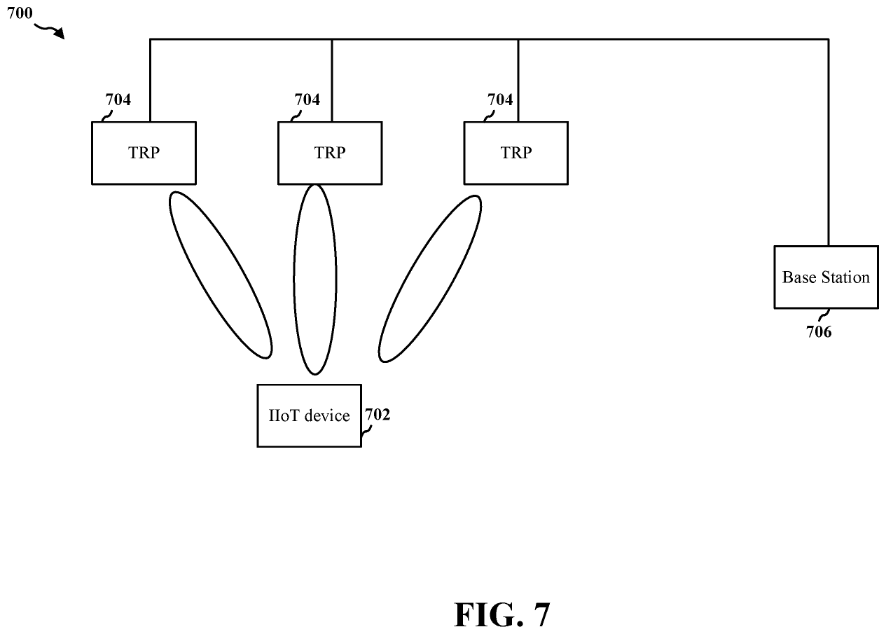

FIG. 7 is an example 700 of an industrial IoT (IIoT) device in a sidelink communication system. The example 700 of FIG. 7 includes an IIoT device 702 (e.g., UE), a plurality of TRPs 704, and a base station 706. The plurality of TRPs 704 may be associated with the base station 706. The base station 706 may comprise a centralized unit or server that may communicate with the IIoT device 702 via one or more of the plurality of TRPs 704. For IIoT, ultra-reliability is required due in part to stringent latency requirements (e.g., within 1 ms). IIoT devices may utilize a reduced data rate, such as a few kbps to Mbps. IIoT devices may experience challenges in RF environments due to blockage of communication signals from nearby machinery. Multiple TRPs utilized together may for an mTRP system, which may be deployed in an effort to enhance data transfer. A single TRP may be used in instances where the link between the TRP and the IIoT device is consistently good, e.g., consistently meeting particular latency and/or quality levels. However, in instances where the link between the TRP and the IIoT device becomes degraded or unreliable, a switch may be made to provide a different link that is more reliable. In some instances, waiting for the IIoT device to transmit an indication of a degradation of link quality (e.g., NAK) may be inefficient due to latency requirements for IIoT. In IIoT, sidelink may enable direct programmable logical controller (PLC) and sensors/actuators (S/As) communication. A wireless PLC may provide flexible and simple deployment. A PLC may be configured to control 20-50 S/As. Wireless PLCs may have a latency of 1-2 ms and reliability requirements on the order of a 10⁻⁶ error rate. Communication through a base station may require multiple over the air signals, which may affect latency and reliability. IIoT traffic may be deterministic and may have small packet sizes of approximately 32-256 Bytes. The bandwidth for such communication may be low, such as 2 RBs in some cases. S/As may exchange wireless communication as a UE and may have reduced UE capabilities that correspond to bandwidth and processing power. The overall bandwidth may be large for IIoT with dedicated frequency bands and/or unlicensed bands. S/As may not be expected to detect or monitor all transmissions.

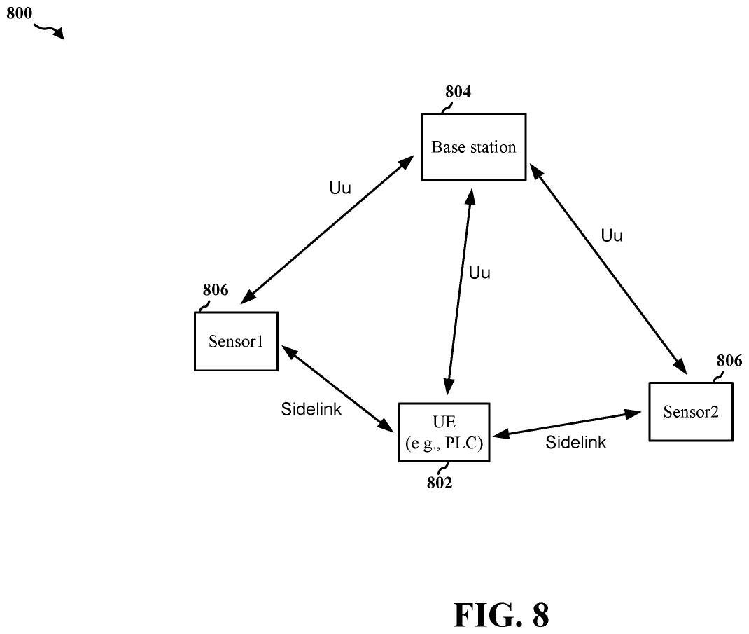

FIG. 8 is an example 800 of an IIoT device in a sidelink communication system. The example 800 of FIG. 8 includes a UE 802 (e.g., PLC), a plurality of sensors 806 (e.g., sensor1, sensor 2), and a base station 804. The sensors may each correspond to an S/A, in some aspects. The UE 802 may be configured to communicate with the base station 804 via a Uu link, while the UE 802 and may be configured to communicate with the sensors via sidelink. The sensors may communicate with the base station via a respective Uu link. The UE 802 having one or more sidelinks may allow for multi-path diversity. If a sidelink is blocked or not reliable, another sidelink, or a Uu link, may be utilized to ensure added reliability. Similarly, if a Uu link is blocked, one or more sidelinks may be used to provide transmit diversity. Path switching between sidelink and Uu assists in improving reliability and latency of wireless communication. Multi-path diversity may allow for joint sidelink and Uu operation to provide a high reliability. However, such reliability may be at the expense of an increase in power consumption. In some aspects, switching between transmission modes may be based on the channel state information (CSI) of a link. Efficient and accurate switching may be referred to as seamless switching in some aspects. For example, a single TRP or sidelink may be sufficient (e.g., meet quality, reliability, etc. thresholds) in some instances. The base station may switch a transmission state to mTRP or joint sidelink and Uu operation in instances where the link has degraded or has fallen below a threshold. The change in the link quality may be indicated via a CSI measurement and feedback. However, constant CSI feedback may introduce an increase in signaling overhead.

Aspects presented herein provide a configuration for signaling that enables a state transition of transmission mode. The signaling may include a reduced signaling or modified CSI feedback signal that enables the state transition of the transmission mode based on the measurement of the link quality.

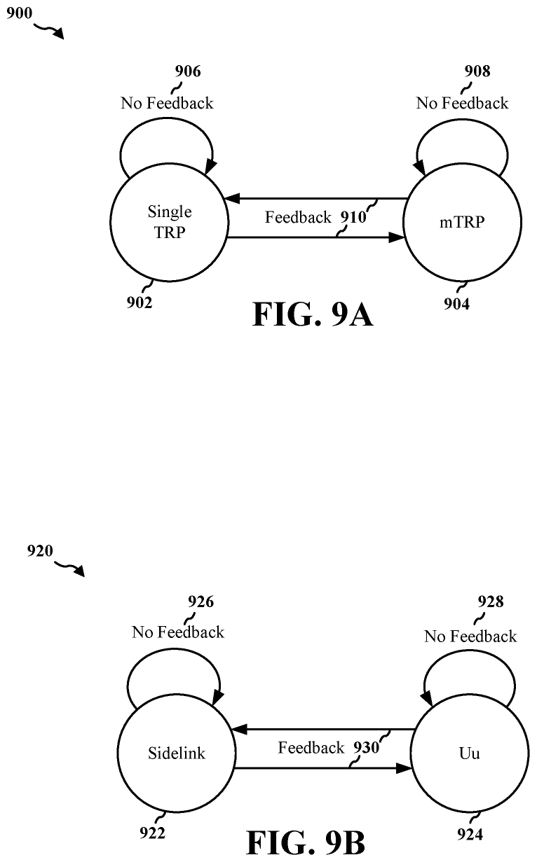

FIG. 9A is an example 900 of transitions between transmission mode states for a UE. The UE may operate in a single TRP state 902. The UE may measure at least one reference signal from the serving TRP. The UE does not send a feedback signal 906 in instances where the measurements of the at least one reference signal from the serving TRP indicate that the link between the UE and the serving TRP are good or satisfactory (e.g., meets a threshold level for quality, latency, or another metric) for the current operation (e.g., single TRP or mTRP). In some aspects, the measurements of the at least one reference signal may indicate that the link is above a threshold, such that the link between the UE and the serving TRP are good or satisfactory. The UE may perform the measurement based on the reference signal and may send feedback 910 in instances where measurements of the at least one reference signal indicate that the link has degraded or has fallen below the threshold. In such instances, the feedback signal 910 may request a switch of the transmission mode. For example, the base station may switch between a single TRP state 902 and mTRP state 904 upon receipt of the feedback signal 910 from the UE. In some aspects, the UE may be in the mTRP state 904 and may remain in the mTRP state 904 if the link is good based on measurements of the at least one reference signal. The UE may transmit the feedback signal 910 to request a switch from the mTRP state 904 to the single TRP state 902 if the link has improved or has a measurement above a threshold. The feedback signal 910 may comprise CSI configured as a single bit feedback signal or a multi-bit feedback signal for purposes of triggering a transmission state transition. In some aspects, the feedback bit may indicate a change to a different mTRP modes. For example, a first feedback bit may indicate a transition from a single TRP state to a first mTRP mode, while a second feedback bit may indicate a transition from the single TRP state to a second mTRP mode.

With reference to FIG. 9B, the UE may operate in a sidelink state 922 and measurements of the at least one reference signal may indicate that the link is good or satisfactory for the current state, such that no feedback 926 is sent and the UE remains in the sideline state 922. In instances where the measurements of the at least one reference signal indicate that the link between the UE and the TRP is degraded or falls below a threshold, the UE may send a feedback signal 930. The feedback signal 930 may request a switch of the transmission mode, such that the base station may switch between the sidelink transmission state 922 and a Uu transmission state 924. In some aspects, while in Uu transmission state 924, the UE may measure the at least one reference signal and may remain in the Uu transmission state 924 if the link is good, such that the UE does not send a feedback signal (e.g., no feedback 928). If the link quality degrades or falls below the threshold, the UE may transmit the feedback signal 930 to request a state change from Uu transmission state 924 to a state that includes the sidelink transmission 922.

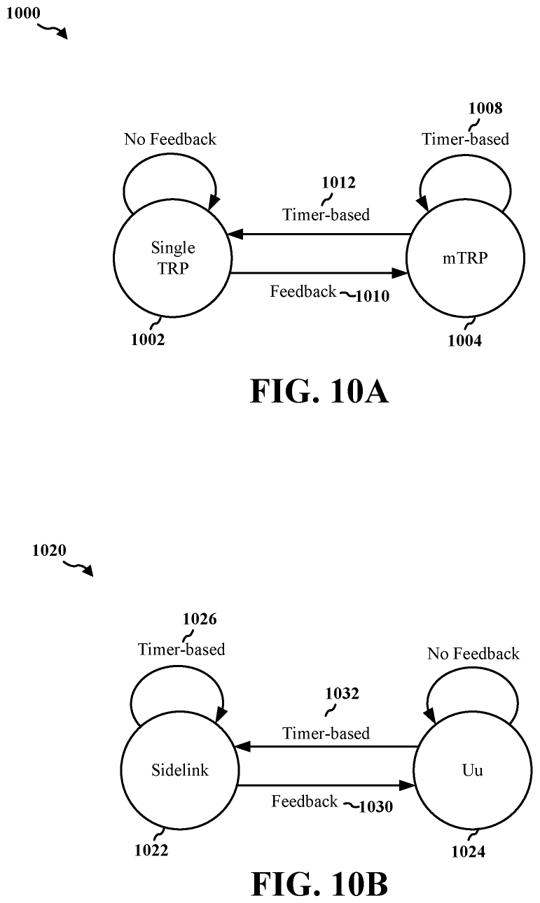

In some aspects, such as in example 1000 of FIG. 10A, the state transition from a mTRP state to a single TRP state or from a joint Uu and sidelink transmissions state to a Uu transmission state or a single sidelink transmission state may be timer based, such that the transmission state of the UE may switch back to a prior transmission state upon the expiration of a timer. For example, the UE may operate in the single TRP state 1002 and may transmit a feedback signal 1010 to switch to the mTRP state 1004. The UE may continue to operate in the mTRP state 1004 for a period of time. Upon the expiration of the period of time, the UE may send a feedback signal (e.g., 1012) to switch to the single TRP state 1002. Alternatively, the UE may transition to the single TRP state 1002 based on expiration of the timer. In some aspects, the UE may measure the at least one reference signal and continue to operate in the mTRP state 1004 if the link is good or is above a threshold, such that the UE does not send a feedback signal (e.g., 1008). In the aspect of example 1020 of FIG. 10B, the UE may operate in a sidelink state 1022 for a period of time (e.g., 1026). The UE may send a feedback signal 1030 if the link quality degrades or falls below a threshold and switch to the Uu state 1024. The UE may operate in the Uu state 1024 for a period of time, such that upon the expiration of the period of time, the UE sends a feedback signal (e.g., 1032) to switch to the sidelink state 1022. Alternatively, the UE may transition to the prior state (e.g., sidelink 1022) based on expiration of the timer.

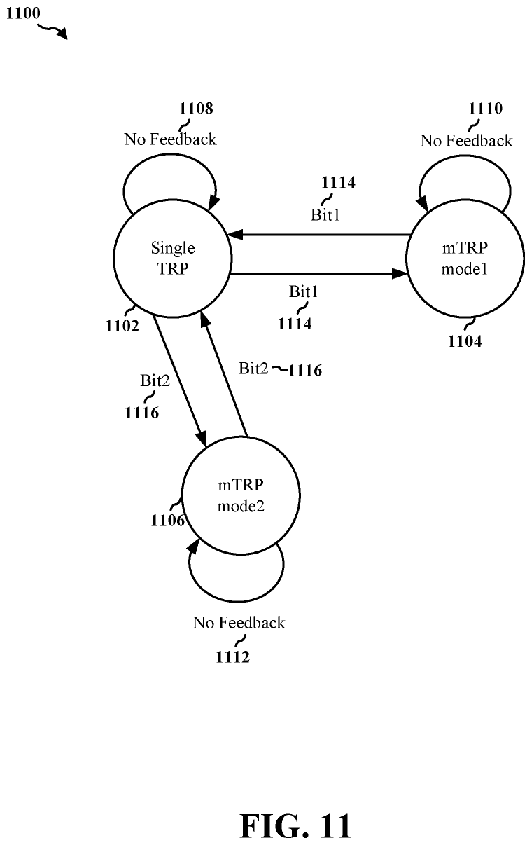

FIG. 11 is an example 1100 of aspects of transition between transmission mode states for a UE. The UE may be configured to transmit a feedback signal comprising at least one bit that indicates a state transition based on the at least one bit. In some aspects, the feedback indicating the state transition may include a single bit. For example, the UE may operate in the single TRP state 1102 and may transmit a feedback signal comprising a first bit (e.g., Bit1 1114) or a second bit (e.g., Bit2 1116), where the bit transmitted within the feedback signal indicates a request to switch to a particular state. In some aspects, the first bit (e.g., Bit1 1114) may indicate a switch to a first mTRP mode (e.g., mTRP mode1 1104), while the second bit (e.g., Bit2 1116) may indicate a switch to a second mTRP mode (e.g., mTRP mode2 1106). The UE, while in the first mTRP mode (e.g., mTRP model 1104) may measure the at least one reference signal and may remain in the first mTRP mode if the measurements indicate that the link is good, such that the UE does not transmit a feedback signal (e.g., no feedback 1110). The UE may switch from the first mTRP mode to the single TRP mode if the link quality is degraded or falls below a threshold, such that the UE transmits the feedback signal comprising the first bit (e.g., Bit1 1114). The UE, while in the second mTRP mode (e.g., mTRP mode2 1106) may measure the at least one reference signal and may remain in the second mTRP mode if the measurements indicate that the link is good, such that the UE does not transmit a feedback signal (e.g., no feedback 1112). The UE may switch from the second mTRP mode to the single TRP mode if the link quality is degraded or falls below a threshold, such that the UE transmits the feedback signal comprising the second bit (e.g., Bit2 1116). In some aspects, if the UE sends a feedback signal comprising an invalid bit, then the base station may be configured to initiate a procedure to verify the transmission state of the UE. For example, if the UE is operating in mTRP model 1104 and the UE determines that the link is degraded or has fallen below the threshold, but sends a feedback signal comprising Bit2 1116, the base station may initiate a procedure to verify the current transmission state of the UE based on receiving an invalid feedback bit. The base station is configured to receive a feedback signal comprising a particular bit (e.g., Bit1 1114) to transition between single TRP state 1102 and mTRP model 1104. As such, receipt of an invalid feedback bit, by the base station, may trigger the procedure to verify the current transmission state of the UE. For example, the base station may transmit a signal comprising a request for the current transmission state of the UE. The signal may be provided to a TRP for delivery to the UE. The UE, in response to receiving the request for the current transmission state of the UE, may transmit a report indicating the current transmission state of the UE. In some aspects, the base station may transmit the request for the UE to report its current transmission state via DCI, MAC-CE, or RRC.

In some aspects, the first mTRP mode (e.g., mTRP mode1 1104) may be associated with a first subset TRPs from a plurality of TRPs. In some aspects, the second mTRP mode (e.g., mTRP mode2 1106) may be associated with a second subset of TRPs from the plurality of TRPs. In some aspects, the state transition may be user specific. For example, the first mTRP mode (e.g., mTRP mode1 1104) may be configured for a first UE, while the second mTRP mode (e.g., mTRP mode2 1106) may be configured for a second UE.

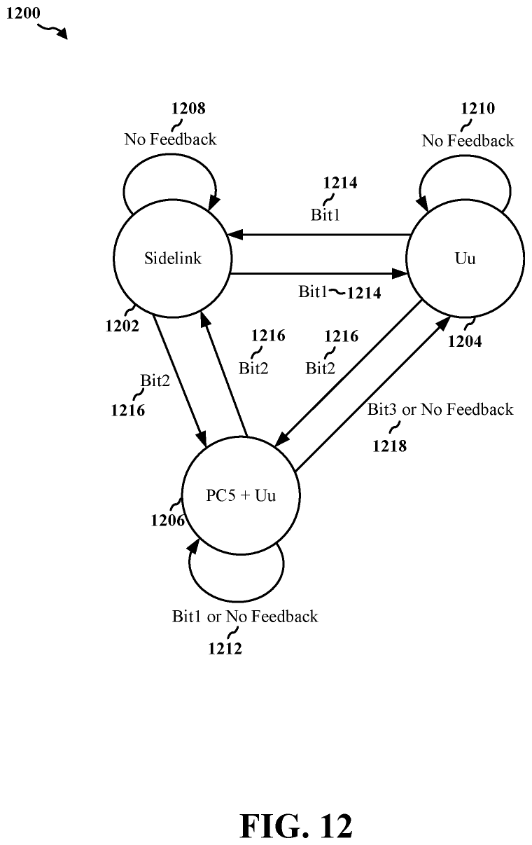

FIG. 12 is an example 1200 of transmission mode states for a UE. In some aspects, the UE may be configured to transition between a plurality of states. In some aspects, the plurality of states may comprise three states. In some aspects, the plurality of state may comprise more than three states. The three states may comprise a sidelink state 1202, a Uu state 1204, or a PC5 and Uu state 1206. The state transitions between the states may be triggered based on transmission of a feedback signal or the absence of the transmission of the feedback signal. Each feedback signal may trigger a state transition to another state or to stay in a current state. The feedback signal may comprise multiple feedback bits, such that feedback bits may correspond to one or more state transitions. For example, the UE may operate in sidelink state 1202, and may remain in sidelink state 1202 based on a good link quality, such that the UE does not transit a feedback signal (e.g., no feedback 1208). The UE may transition to a Uu state 1204 or the PC5 and Uu state 1206 by transmitting a feedback signal having a corresponding feedback bit. For example, the UE may transition to the Uu state 1204 from the sidelink state 1202 by transmitting a feedback signal comprising the feedback bit Bit1 1214. The UE may transition to the PC5 and Uu state 1206 from the sidelink state 1202 by transmitting a feedback signal comprising the feedback bit Bit2 1216. The UE may remain in the Uu state 1204 by not transmitting a feedback signal (e.g., no feedback 1210). The UE may remain in the PC5 and Uu state 1206 by not transmitting a feedback signal or by transmitting a signal comprising the feedback bit Bit1 1212. In some aspects, the UE, while in the Uu state 1204, may transition to the PC5 and Uu state 1206 by transmitting a feedback signal comprising a feedback bit Bit2 1216. The UE, while in the Uu state 1204, may transition to the sidelink state 1202 by transmitting a feedback signal comprising a feedback bit Bit1 1214. The UE, while in the PC5 and Uu state 1206 may transition to the sidelink state 1202 by transmitting a feedback signal comprising a feedback bit Bit2 1216. The UE, while in the PC5 and Uu state 1206 may transition to the Uu state 1204 by transmitting a feedback signal comprising a feedback bit Bit3 1218. The UE transmits the feedback signal if the link quality has degraded or has fallen below a threshold. In some aspects, the feedback bits may be represented as a particular sequence of bits. In some aspects, the feedback bits may be represented by a waveform sequence (e.g., PUCCH format 0 with different Zadoff-Chu sequence). In some aspects, feedback bits triggering a state transition may indicate the state, e.g., the first two feedback bits may indicate the state of the UE.

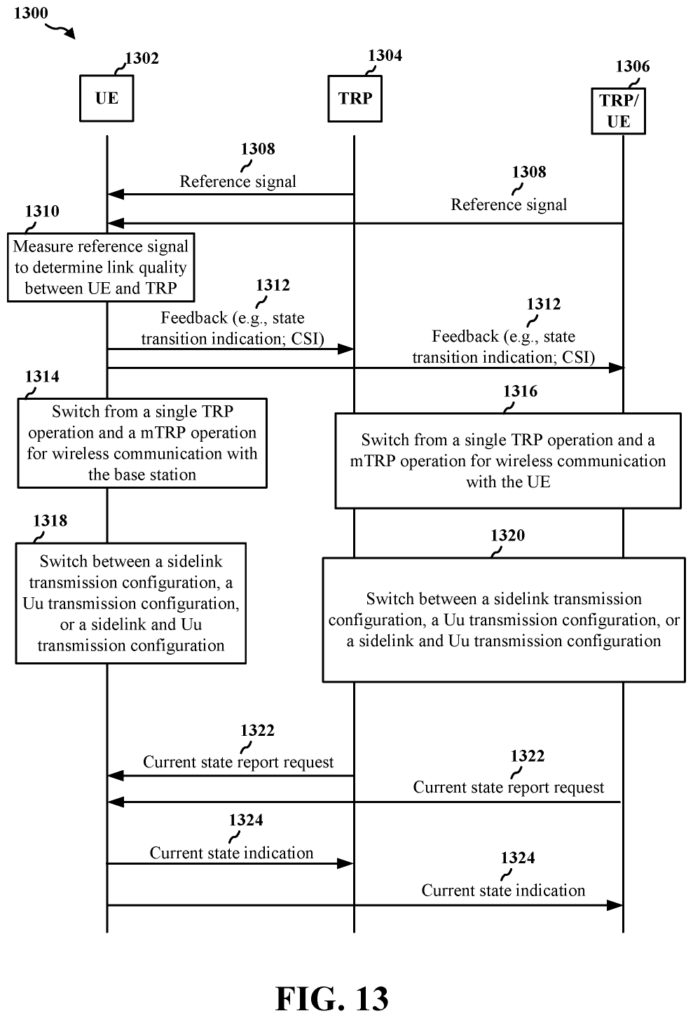

FIG. 13 is a call flow diagram 1300 of signaling involving a transmission mode state transmission for a UE 1302. The UE may exchange wireless communication with a base station having at least one TRP 1304. In some aspects, a transmission mode state may include reception from a different TRP/UE 1306, such as a second TRP of the base station or via a sidelink connection with a UE or S/A. The base station may be configured to provide at least one cell, e.g., via one or more TRPs. Although FIG. 13 only shows two TRPs, the base station may include three or more TRPs, and the aspects presented herein are applicable to different numbers of TRPs that may be used for mTRP communication with the UE 1302. Similarly, a transmission mode of the UE 1302 may include sidelink communication with one or more other UEs or S/As. The UE 1302 may be configured to communicate with the first TRP 1304 and/or the TRP/UE 1306. For example, in the context of FIG. 1, the TRP 1304 (and similarly 1306) may be a TRP of a base station 102/180 and, accordingly, the cell may include a geographic coverage area 110 in which communication coverage is provided and/or small cell 102′ having a coverage area 110′. Further, a UE 1302 may correspond to at least UE 104. In another example, in the context of FIG. 3, the base station (including TRP 1304 and/or 1306) may correspond to the device 310 and the UE 1302 may correspond to the device 350.

As illustrated at 1308, the base station may transmit at least one reference signal to the UE 1302. The base station may transmit the at least one reference signal via the TRP 1304. The UE 1302 may receive the at least one reference signal. The TRP 1304 may be serving the UE 1302, such that the TRP 1304 may be a serving TRP.

As illustrated at 1310, the UE 1302 may measure the at least one reference signal received from the TRP 1304. The UE may measure the at least one reference signal from the TRP to determine a link quality between the UE and the TRP.

As illustrated at 1312, the UE 1302 may transmit feedback including a state transition indication to the base station (e.g., via the TRP 1304). The UE may transmit the feedback including the state transition indication if the link quality between the UE and the serving TRP falls below a threshold, such that wireless communication has degraded due to a reduction of the link quality. The threshold may be preconfigured or configurable. The feedback may enable a state transition of a transmission mode. In some aspects, the feedback may comprise CSI. The state transition indication may comprise one or more feedback bits that indicates feedback for the state transition of the transmission mode. In some aspects, a single feedback bit may indicate a request for the state transition between a single TRP operation and a multi-TRP (mTRP) operation. In some aspects, a plurality of feedback bits may indicate a request for the state transition between a single TRP operation and a plurality of modes of mTRP operations. In some aspects, the state transition of the transmission mode may be a first state transition and a second state transition after the first state transition may be based on a timer. The second state transition may occur upon expiration of the timer. The timer may be based on at least one of a number of slots, a number of transmissions, or a number of acknowledgement (ACK)/negative acknowledgement (NACK) transmitted by the UE. The timer may be preconfigured or configurable.

As illustrated at 1314, the UE 1302 may switch from a single TRP operation and an mTRP operation for wireless communication with a base station (e.g., via TRP 1304 and similarly 1306 in an example in which 1306 is a second TRP of the base station) after transmission of the state transition indication. The transmission of the feedback comprising the state transition indication may trigger the switch from the single TRP operation and the mTRP operation at the UE. The UE may transmit or receive wireless communication with multiple serving TRPs in the mTRP operation.

As illustrated at 1316, the base station may switch from the single TRP operation and the mTRP operation for wireless communication with the UE 1302. The base station may switch from the single TRP operation and the mTRP operation for wireless communication with the UE after reception of the state transition indication. The reception of the state transition indication, from the UE, may trigger the switch from the single TRP operation and the mTRP operation at the base station. The base station may transmit or receive wireless communication with multiple serving TRPs in the mTRP operation.

As illustrated at 1318, the UE 1302 may switch between two of a sidelink transmission configuration, a Uu transmission configuration, or a sidelink and Uu transmission configuration. The UE may switch between two of the sidelink transmission configuration, the Uu transmission configuration, or the sidelink and Uu transmission configuration after transmission of the state transition indication. The transmission of the state transition indication may trigger the switch of the transmission configuration at the UE. In some aspects, the feedback may comprise CSI. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms. In such aspects, 1306 may be a UE that communicates with the UE 1302 via sidelink.

As illustrated at 1320, a switch may be performed between two of a sidelink transmission configuration, a Uu transmission configuration, or a sidelink and Uu transmission configuration. In some aspects, the base station may switch between two of the sidelink transmission configuration, the Uu transmission configuration, or the sidelink and Uu transmission configuration after reception of the state transition indication. The reception of the state transition indication may trigger the switch of the transmission configuration at the base station. In some aspects, the feedback may comprise CSI. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

As illustrated at 1322, the base station may transmit a request to report a current state of the transmission mode, e.g., via the TRP 1304. The base station may transmit the request to report the current state of the transmission mode to the UE. The UE 1302 may receive the request to report the current state of the transmission mode.

As illustrated at 1324, the UE 1302 may transmit an indication comprising the current state of the transmission mode of the UE. The UE may transmit the indication comprising the current state of the transmission mode to the serving TRP or the base station associated with the serving TRP. The TRP may provide the indication comprising the current state of the transmission mode to the base station. The UE may transmit the indication comprising the current state of the transmission mode in response to receipt of the request to report the current state of the transmission mode.

In some aspects in which the UE is transition between one or more modes including sidelink, the reference signal 1308 and/or the request 1322 may be transmitted by a UE (e.g., 1306). The UE may transmit the feedback 1312 and/or the state report 1324 to the UE (e.g., 1306).

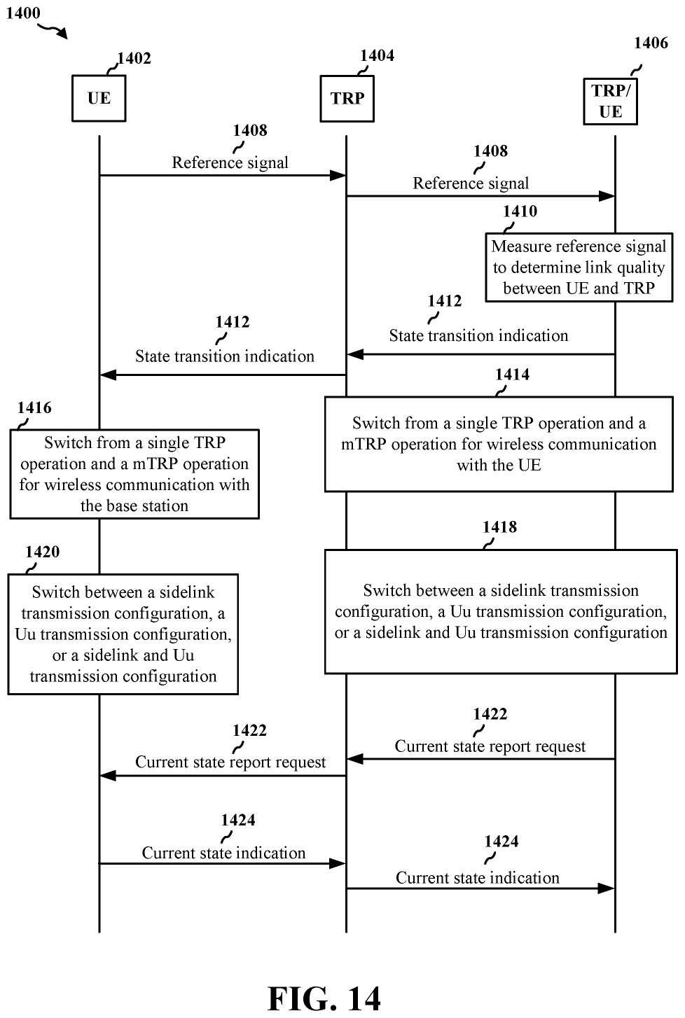

FIG. 14 is a call flow diagram 1400 of signaling including a transmission state transmission for a UE 1402. The UE may communicate with a base station having one or more TRPs, including the TRP 1404. In one or more transmission mode states, the UE 1402 may also communicate via a different TRP/UE 1406, such as a second TRP of the base station or via a sidelink connection with a UE or S/A. Although FIG. 14 only shows two TRPs, the base station may include three or more TRPs, and the aspects presented herein are applicable to different numbers of TRPs that may be used for mTRP communication with the UE 1402. Similarly, a transmission mode of the UE 1302 may include sidelink communication with one or more other UEs or S/As The UE 1402 may be configured to communicate with the base station, e.g., via a Uu link with one or more TRPs, and/or another UE or S/A, e.g., via a sidelink with one or more UEs or S/As. For example, in the context of FIG. 1, the base station having the one or more TRPs may correspond to base station 102/180 and, accordingly, the cell provided through the one or more TRPs may include a geographic coverage area 110 in which communication coverage is provided and/or small cell 102′ having a coverage area 110′. Further, a UE 1402 may correspond to at least UE 104. The TRP 1404, and similarly 1406, may be associated with base station 102/180. In another example, in the context of FIG. 3, the base station may correspond to the device 310 and the UE 1402 may correspond to the device 350.

As illustrated at 1408, the UE 1402 may transmit at least one reference signal. The UE may transmit the at least one reference signal to the TRP 1404 associated with the base station and/or to a second TRP of the base station or a UE (e.g., TRP/UE 1406). The base station may receive the at least one reference signal. In some aspects, the TRP 1404 may be serving the UE 1402, such that the TRP 1404 may be a serving TRP.

As illustrated at 1410, the base station may measure the at least one reference signal.

The base station may measure the at least one reference signal received from the UE. The base station may measure the at least one reference signal to determine a link quality between the UE and a serving TRP.

As illustrated at 1412, the base station may transmit a state transition indication. The base station may transmit the state transition indication to the UE 1402. The base station may transmit the state transition indication to the TRP 1404. The TRP 1404 may provide the state transition indication to the UE 1402. The UE 1402 may receive the state transition indication. The base station may transmit the state transition indication if the link quality between the UE and the serving TRP falls below a threshold, such that wireless communication has degraded due to a reduction of the link quality. The threshold may be preconfigured or configurable. The state transition indication may enable a state transition of a transmission mode. In some aspects, the feedback may comprise CSI. The state transition indication may comprise one or more feedback bit that indicates feedback for the state transition of the transmission mode. In some aspects, a single feedback bit may indicate a request for the state transition between a single TRP operation and an mTRP operation. In some aspects, a plurality of feedback bits may indicate a request for the state transition between the single TRP operation and a plurality of modes of mTRP operations. In some aspects, the state transition of the transmission mode may be a first state transition and a second state transition after the first state transition may be based on a timer. The second state transition may occur upon expiration of the timer. The timer may be based on at least one of a number of slots, a number of transmissions, or a number of ACK/NACK received by the base station. The timer may be preconfigured or configurable.

As illustrated at 1414, the base station may switch from a single TRP operation and an mTRP operation for wireless communication with the UE after transmission of the state transition indication. The transmission of the state transition indication may trigger the switch from the single TRP operation and the mTRP operation at the base station.

As illustrated at 1416, the UE 1402 may switch from the single TRP operation and the mTRP operation for wireless communication with the base station. The UE may switch from the single TRP operation and the mTRP operation for wireless communication with the base station after receipt of the state transition indication. The reception of the state transition indication may trigger the switch from the single TRP operation and the mTRP operation at the UE. The UE may transmit or receive wireless communication with multiple serving TRPs in the mTRP operation.

As illustrated at 1418, the base station may switch between two of a sidelink transmission configuration, a Uu transmission configuration, or a sidelink and Uu transmission configuration. The base station may switch between two of the sidelink transmission configuration, the Uu transmission configuration, or the sidelink and Uu transmission configuration after transmission of the state transition indication. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

As illustrated at 1420, the UE 1402 may switch between two of a sidelink transmission configuration, a Uu transmission configuration, or a sidelink and Uu transmission configuration. The UE may switch between two of the sidelink transmission configuration, the Uu transmission configuration, or the sidelink and Uu transmission configuration after receipt of the state transition indication. The reception of the state transition indication may trigger the switch of the transmission configuration at the UE. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

As illustrated at 1422, the base station may transmit a request to report a current state of the transmission mode. The base station may transmit the request to report the current state of the transmission mode to the UE. The base station may transmit the request to report the current state of the transmission mode to the TRP 1404. The TRP 1404 may provide the request to the UE 1402. The UE 1402 may receive the request to report the current state of the transmission mode.

As illustrated at 1424, the UE 1402 may transmit an indication comprising the current state of the transmission mode of the UE. The UE may transmit the indication comprising the current state of the transmission mode to the serving TRP or the base station associated with the serving TRP. The TRP may provide the indication comprising the current state of the transmission mode to the base station. The UE may transmit the indication comprising the current state of the transmission mode in response to receipt of the request to report the current state of the transmission mode.

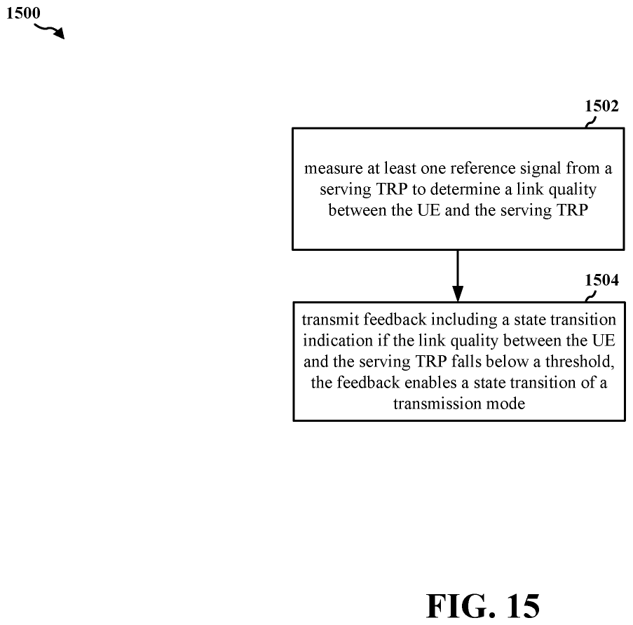

FIG. 15 is a flowchart 1500 of a method of wireless communication. The method may be performed by a UE or a component of a UE (e.g., the UE 104; the apparatus 1902; the cellular baseband processor 1904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to switch between transmission modes based on a link quality between the UE and a serving TRP.

At 1502, the UE may measure at least one reference signal from a serving TRP. For example, 1502 may be performed by reference signal component 1940 of apparatus 1902. The UE may measure the at least one reference signal from the serving TRP to determine a link quality between the UE and the serving TRP.

At 1504, the UE may transmit feedback including a state transition indication. For example, 1504 may be performed by indication component 1942 of apparatus 1902. The UE may transmit the feedback including the state transition indication if the link quality between the UE and the serving TRP falls below a threshold. The feedback may enable a state transition of a transmission mode. In some aspects, the feedback may comprise CSI. The state transition indication may comprise one or more feedback bits that indicates feedback for the state transition of the transmission mode. In some aspects, a single feedback bit may indicate a request for the state transition between a single TRP operation and an mTRP operation. In some aspects, a plurality of feedback bits may indicate a request for the state transition between a single TRP operation and a plurality of modes of mTRP operations. In some aspects, the state transition of the transmission mode may be a first state transition and a second state transition after the first state transition may be based on a timer. The second state transition may occur upon expiration of the timer. The timer may be based on at least one of a number of slots, a number of transmissions, or a number of ACK/NACK transmitted by the UE.

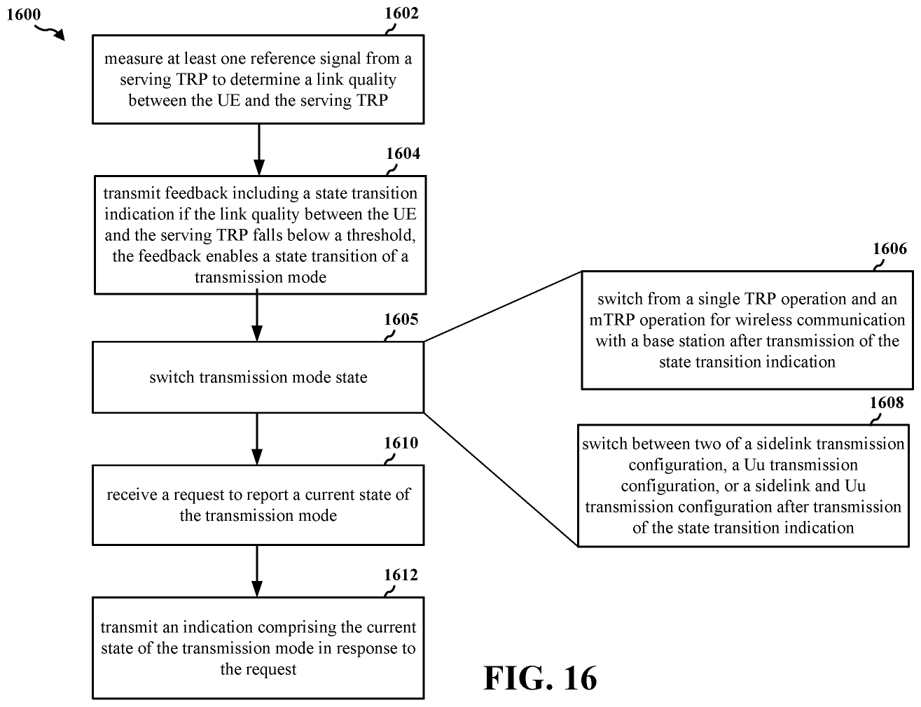

FIG. 16 is a flowchart 1600 of a method of wireless communication. The method may be performed by a UE or a component of a UE (e.g., the UE 104; the apparatus 1902; the cellular baseband processor 1904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to switch between transmission modes based on a link quality between the UE and a serving TRP.

At 1602, the UE may measure at least one reference signal from a serving TRP. For example, 1602 may be performed by reference signal component 1940 of apparatus 1902. The UE may measure the at least one reference signal from the serving TRP to determine a link quality between the UE and the serving TRP.

At 1604, the UE may transmit feedback including a state transition indication. For example, 1604 may be performed by indication component 1942 of apparatus 1902. The UE may transmit the feedback including the state transition indication if the link quality between the UE and the serving TRP falls below a threshold. The feedback may enable a state transition of a transmission mode. In some aspects, the feedback may comprise CSI. The state transition indication may comprise one or more feedback bits that indicates feedback for the state transition of the transmission mode. In some aspects, a single feedback bit may indicate a request for the state transition between a single TRP operation and an mTRP operation. In some aspects, a plurality of feedback bits may indicate a request for the state transition between a single TRP operation and a plurality of modes of mTRP operations. In some aspects, the state transition of the transmission mode may be a first state transition and a second state transition after the first state transition may be based on a timer. The second state transition may occur upon expiration of the timer. The timer may be based on at least one of a number of slots, a number of transmissions, or a number of ACK/NACK transmitted by the UE.

At 1605, the UE may switch between transmission mode states. For example, at 1606, the UE may switch from a single TRP operation and an mTRP operation for wireless communication with a base station. For example, 1606 may be performed by switch component 1944 of apparatus 1902. The UE may switch from the single TRP operation and the mTRP operation for wireless communication with the base station after transmission of the state transition indication. The UE may transmit or receive wireless communication with multiple serving TRPs in the mTRP operation.

As another example, at 1608, the UE may switch between two of a sidelink transmission configuration, a Uu transmission configuration, or a sidelink and Uu transmission configuration. For example, 1608 may be performed by switch component 1944 of apparatus 1902. The UE may switch between two of the sidelink transmission configuration, the Uu transmission configuration, or the sidelink and Uu transmission configuration after transmission of the state transition indication. In some aspects, the feedback may comprise CSI. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

At 1610, the UE may receive a request to report a current state of the transmission mode. For example, 1610 may be performed by state component 1946 of apparatus 1902. The UE may receive the request to report the current state of the transmission mode from the serving TRP or the base station associated with the serving TRP.

At 1612, the UE may transmit an indication comprising the current state of the transmission mode. For example, 1612 may be performed by indication component 1942 of apparatus 1902. The UE may transmit the indication comprising the current state of the transmission mode to the serving TRP or the base station associated with the serving TRP. The UE may transmit the indication comprising the current state of the transmission mode in response to receipt of the request to report the current state of the transmission mode.

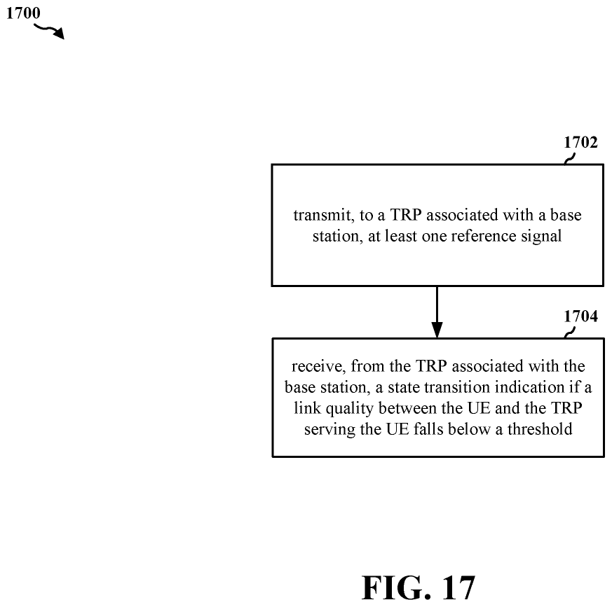

FIG. 17 is a flowchart 1700 of a method of wireless communication. The method may be performed by a UE or a component of a UE (e.g., the UE 104; the apparatus 1902; the cellular baseband processor 1904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to switch between transmission modes based on a link quality between the UE and a serving TRP.

At 1702, the UE may transmit at least one reference signal. For example, 1702 may be performed by reference signal component 1940 of apparatus 1902. The UE may transmit the at least one reference signal to a TRP associated with a base station.

At 1704, the UE may receive a state transition indication. For example, 1704 may be performed by indication component 1942 of apparatus 1902. The UE may receive the state transition indication from the TRP associated with the base station. The UE may receive the state transition indication if a link quality between the UE and the TRP serving the UE falls below a threshold. The link quality may be based on the at least one reference signal transmitted by the UE. The state transition indication may enable a state transition of a transmission mode.

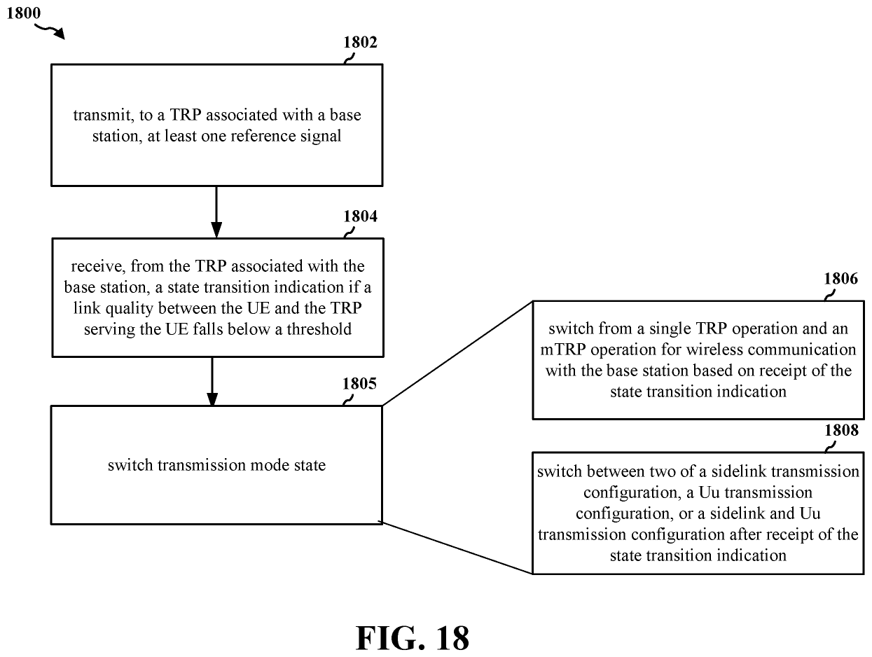

FIG. 18 is a flowchart 1800 of a method of wireless communication. The method may be performed by a UE or a component of a UE (e.g., the UE 104; the apparatus 1902; the cellular baseband processor 1904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to switch between transmission modes based on a link quality between the UE and a serving TRP.

At 1802, the UE may transmit at least one reference signal. For example, 1802 may be performed by reference signal component 1940 of apparatus 1902. The UE may transmit the at least one reference signal to a TRP associated with a base station.

At 1804, the UE may receive a state transition indication. For example, 1804 may be performed by indication component 1942 of apparatus 1902. The UE may receive the state transition indication from the TRP associated with the base station. The UE may receive the state transition indication if a link quality between the UE and the TRP serving the UE falls below a threshold. The link quality may be based on the at least one reference signal transmitted by the UE. The state transition indication may enable a state transition of a transmission mode.

At 1805, the UE may switch between transmission mode states. For example, at 1806, the UE may switch from a single TRP operation and an mTRP operation for wireless communication with the base station. For example, 1806 may be performed by switch component 1944 of apparatus 1902. The UE may switch from the single TRP operation and the mTRP operation for wireless communication with the base station after receipt of the state transition indication. The UE may transmit or receive wireless communication with multiple serving TRPs in the mTRP operation.

As another example, at 1808, the UE may switch between two of a sidelink transmission configuration, a Uu transmission configuration, or a sidelink and Uu transmission configuration. For example, 1808 may be performed by switch component 1944 of apparatus 1902. The UE may switch between two of the sidelink transmission configuration, the Uu transmission configuration, or the sidelink and Uu transmission configuration after receipt of the state transition indication. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

In some aspects, the UE may receive a request to report a current state of the transmission mode. The UE may receive the request to report the current state of the transmission mode from the serving TRP or the base station associated with the serving TRP. In some aspects, the UE may transmit an indication comprising the current state of the transmission mode. The UE may transmit the indication comprising the current state of the transmission mode to the serving TRP or the base station associated with the serving TRP. The UE may transmit the indication comprising the current state of the transmission mode in response to receipt of the request to report the current state of the transmission mode.

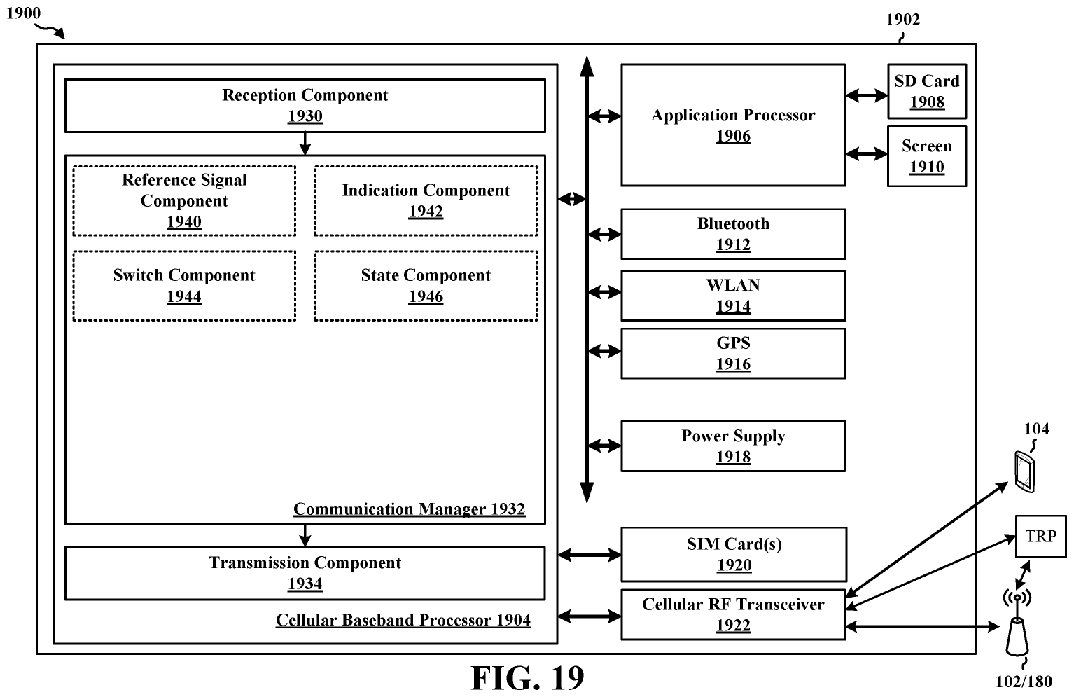

FIG. 19 is a diagram 1900 illustrating an example of a hardware implementation for an apparatus 1902. The apparatus 1902 may be a UE, a component of a UE, or may implement UE functionality. In some aspects, the apparatus 1702 may include a cellular baseband processor 1904 (also referred to as a modem) coupled to a cellular RF transceiver 1922. In some aspects, the apparatus 1902 may further include one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, or a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the cellular baseband processor 1904, and in another configuration, the apparatus 1902 may be the entire UE (e.g., see 350 of FIG. 3) and include the additional modules of the apparatus 1902.

The communication manager 1932 includes a reference signal component 1940 that is configured to measure at least one reference signal from a serving TRP, e.g., as described in connection with 1502 of FIG. 15 or 1602 of FIG. 16. The reference signal component 1940 may be configured to transmit at least one reference signal, e.g., as described in connection with 1702 of FIG. 17 or 1802 of FIG. 18. The communication manager 1932 further includes an indication component 1942 that is configured to transmit feedback including a state transition indication, e.g., as described in connection with 1504 of FIG. 15 or 1604 of FIG. 16. The indication component 1942 may be configured to receive a state transition indication, e.g., as described in connection with 1704 of FIG. 17 or 1804 of FIG. 18. The indication component 1942 may be configured to transmit an indication comprising the current state of the transmission mode, e.g., as described in connection with 1612 of FIG. 16. The communication manager 1932 further includes a switch component 1944 that is configured to switch from a single TRP operation and an mTRP operation for wireless communication with a base station, e.g., as described in connection with 1606 of FIG. 16 or 1806 of FIG. 18. The switch component 1944 may be configured to switch between two of a sidelink transmission configuration, a Uu transmission configuration, or a sidelink and Uu transmission configuration, e.g., as described in connection with 1608 of FIG. 16 or 1808 of FIG. 18. The communication manager 1932 further includes a state component 1946 that is configured to receive a request to report a current state of the transmission mode, e.g., as described in connection with 1610 of FIG. 16.

The apparatus may include additional components that perform each of the blocks of the algorithm in the flowcharts of FIGS. 15-18. As such, each block in the flowcharts of FIGS. 15-18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the cellular baseband processor 1904, includes means for measuring at least one reference signal from a serving TRP to determine a link quality between the UE and the serving TRP. The apparatus includes means for transmitting feedback including a state transition indication if the link quality between the UE and the serving TRP falls below a threshold. The feedback enables a state transition of a transmission mode. The apparatus includes means for transmitting, to a TRP associated with a base station, at least one reference signal. The apparatus includes means for receiving, from the TRP associated with the base station, a state transition indication if a link quality between the UE and the TRP serving the UE falls below a threshold. The state transition indication enables a state transition of a transmission mode. The apparatus further includes means for switching from a single TRP operation and an mTRP operation for wireless communication with a base station after transmission of the state transition indication. The UE transmits or receives wireless communication with multiple serving TRPs in the mTRP operation. The apparatus further includes means for switching from a single TRP operation and an mTRP operation for wireless communication with the base station based on receipt of the state transition indication. The apparatus further includes means for switching between two of a sidelink transmission configuration, a Uu transmission configuration, or a sidelink and Uu transmission configuration after transmission of the state transition indication. The apparatus further includes means for switching between two of a sidelink transmission configuration, a Uu transmission configuration, or a sidelink and Uu transmission configuration after receipt of the state transition indication. The apparatus further includes means for receiving a request to report a current state of the transmission mode. The apparatus further includes means for transmitting an indication comprising the current state of the transmission mode in response to the request. The means may be one or more of the components of the apparatus 1902 configured to perform the functions recited by the means. As described supra, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

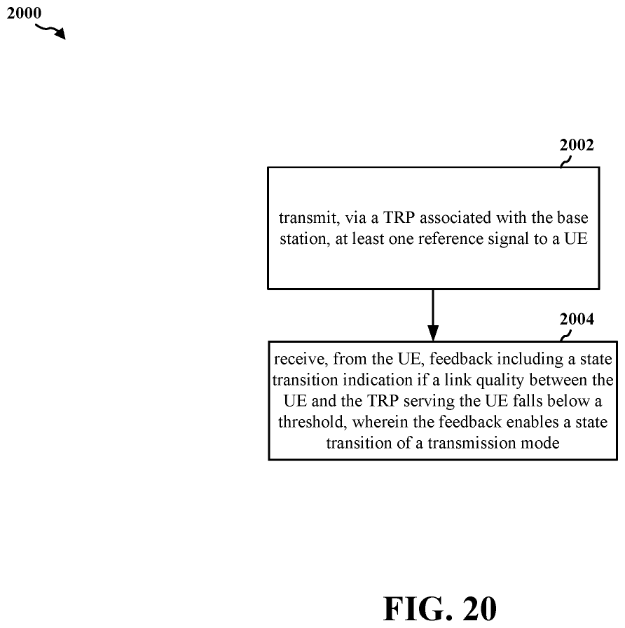

FIG. 20 is a flowchart 2000 of a method of wireless communication. The method may be performed by a base station or a component of a base station (e.g., the base station 102/180; the apparatus 2402; the baseband unit 2404, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to switch between transmission modes based on a link quality between a UE and a serving TRP.

At 2002, the base station may transmit at least one reference signal to a UE. For example, 2002 may be performed by reference signal component 2440 of apparatus 2402. The base station may transmit the at least one reference signal to the UE via a TRP associated with the base station.

At 2004, the base station may receive feedback including a state transition indication. For example, 2004 may be performed by indication component 2442 of apparatus 2402. The base station may receive the feedback including the state transition indication from the UE. The base station may receive the feedback including the state transition indication if a link quality between the UE and the TRP serving the UE falls below a threshold. The feedback signal may enable a state transition of a transmission mode. In some aspects, the feedback may comprise CSI. The state transition indication may comprise one or more feedback bit that indicates feedback for the state transition of the transmission mode. In some aspects, a single feedback bit may indicate a request for the state transition between a single TRP operation and an mTRP operation. In some aspects, a plurality of feedback bits may indicate a request for the state transition between the single TRP operation and a plurality of modes of mTRP operations. In some aspects, the state transition of the transmission mode is a first state transition and a second state transition after the first state transition may be based on a timer. The second state transition may occur upon expiration of the timer. The timer may be based on at least one of a number of slots, a number of transmissions, or a number of ACK/NACK received by the base station.

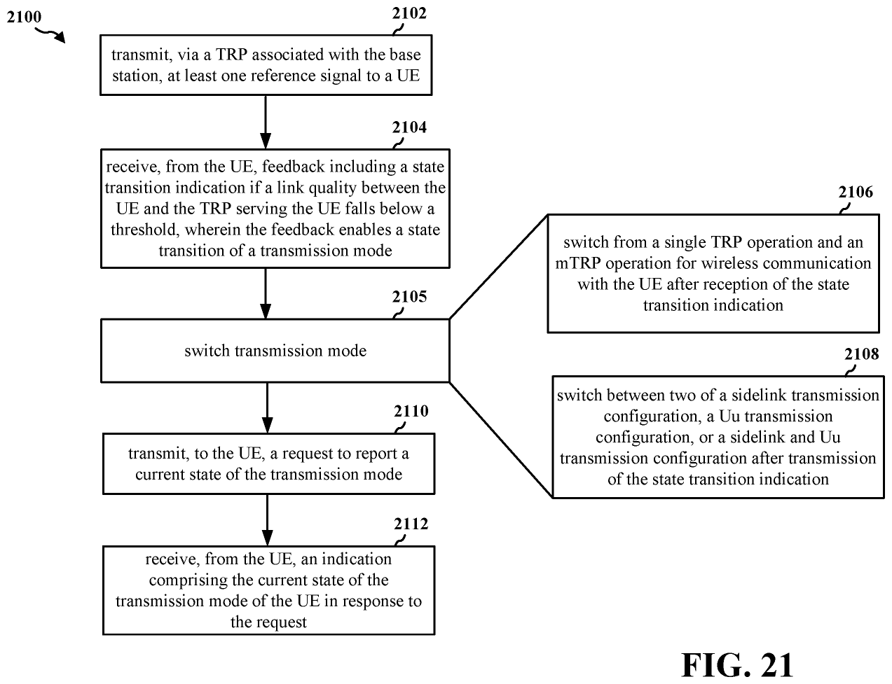

FIG. 21 is a flowchart 2100 of a method of wireless communication. The method may be performed by a base station or a component of a base station (e.g., the base station 102/180; the apparatus 2402; the baseband unit 2404, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to switch between transmission modes based on a link quality between a UE and a serving TRP.

At 2102, the base station may transmit at least one reference signal to a UE. For example, 2102 may be performed by reference signal component 2440 of apparatus 2402. The base station may transmit the at least one reference signal to the UE via a TRP associated with the base station.

At 2104, the base station may receive feedback including a state transition indication. For example, 2104 may be performed by indication component 2442 of apparatus 2402. The base station may receive the feedback including the state transition indication from the UE. The base station may receive the feedback including the state transition indication if a link quality between the UE and the TRP serving the UE falls below a threshold. The feedback signal may enable a state transition of a transmission mode. In some aspects, the feedback may comprise CSI. The state transition indication may comprise one or more feedback bit that indicates feedback for the state transition of the transmission mode. In some aspects, a single feedback bit may indicate a request for the state transition between a single TRP operation and an mTRP operation. In some aspects, a plurality of feedback bits may indicate a request for the state transition between the single TRP operation and a plurality of modes of mTRP operations. In some aspects, the state transition of the transmission mode is a first state transition and a second state transition after the first state transition may be based on a timer. The second state transition may occur upon expiration of the timer. The timer may be based on at least one of a number of slots, a number of transmissions, or a number of ACK/NACK received by the base station.

At 2105, the base station may switch between transmission mode states. For example, at 2106, the base station may switch from a single TRP operation and an mTRP operation for wireless communication with a UE. For example, 2106 may be performed by switch component 2444 of apparatus 2402. The base station may switch from the single TRP operation and the mTRP operation for wireless communication with the UE after reception of the state transition indication. The base station may transmit or receive wireless communication with multiple serving TRPs in the mTRP operation.

As another example, at 2108, the base station may switch between two of a sidelink transmission configuration, a Uu transmission configuration, or a sidelink and Uu transmission configuration. For example, 2108 may be performed by switch component 2444 of apparatus 2402. The base station may switch between two of the sidelink transmission configuration, the Uu transmission configuration, or the sidelink and Uu transmission configuration after reception of the state transition indication. In some aspects, the feedback may comprise CSI. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

At 2110, the base station may transmit a request to report a current state of the transmission mode. For example, 2110 may be performed by state component 2446 of apparatus 2402. The base station may transmit the request to report the current state of the transmission mode to the UE.

At 2112, the base station may receive an indication comprising the current state of the transmission mode. For example, 2112 may be performed by indication component 2442 of apparatus 2402. The base station may receive the indication comprising the current state of the transmission mode from the UE. The UE may transmit the indication comprising the current state of the transmission mode in response to receipt of the request to report the current state of the transmission mode.

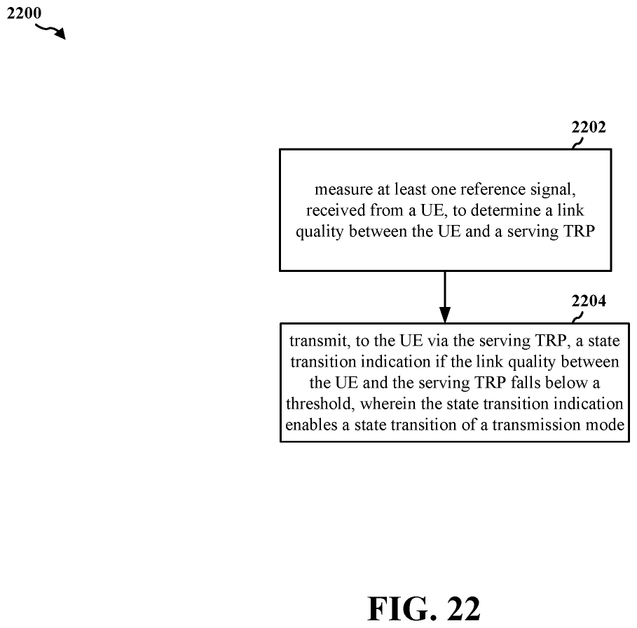

FIG. 22 is a flowchart 2200 of a method of wireless communication. The method may be performed by a base station or a component of a base station (e.g., the base station 102/180; the apparatus 2402; the baseband unit 2404, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to switch between transmission modes based on a link quality between a UE and a serving TRP.

At 2202, the base station may measure at least one reference signal. For example, 2202 may be performed by reference signal component 2440 of apparatus 2402. The base station may measure the at least one reference signal received from a UE. The base station may measure the at least one reference signal to determine a link quality between the UE and a serving TRP.

At 2204, the base station may transmit a state transition indication. For example, 2204 may be performed by indication component 2442 of apparatus 2402. The base station may transmit the state transition indication if the link quality between the UE and the serving TRP falls below a threshold. The state transition indication may enable a state transition of a transmission mode. In some aspects, the feedback may comprise CSI. The state transition indication may comprise one or more feedback bit that indicates feedback for the state transition of the transmission mode. In some aspects, a single feedback bit may indicate a request for the state transition between a single TRP operation and an mTRP operation. In some aspects, a plurality of feedback bits may indicate a request for the state transition between the single TRP operation and a plurality of modes of mTRP operations. In some aspects, the state transition of the transmission mode is a first state transition and a second state transition after the first state transition may be based on a timer. The second state transition may occur upon expiration of the timer. The timer may be based on at least one of a number of slots, a number of transmissions, or a number of ACK/NACK received by the base station.

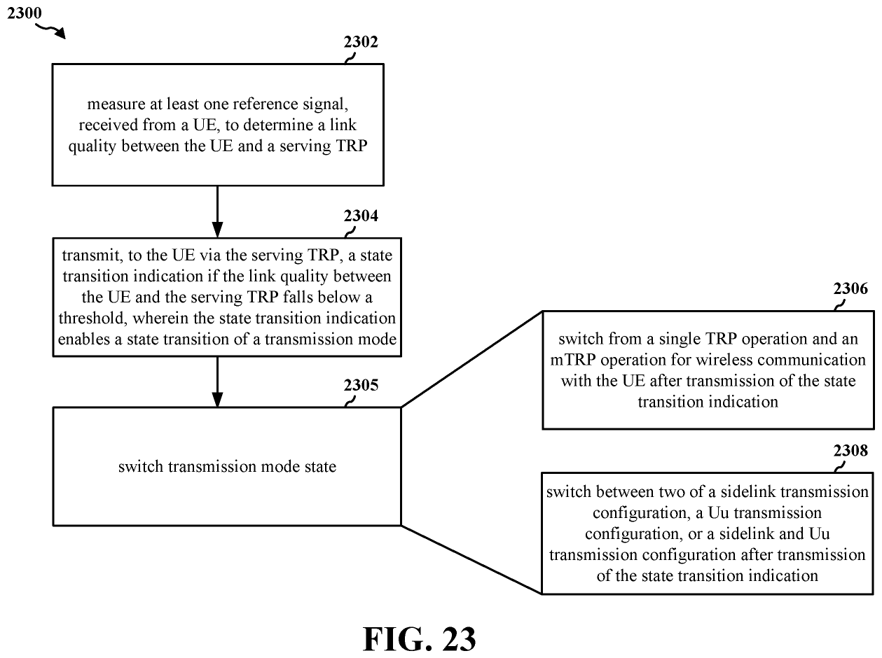

FIG. 23 is a flowchart 2300 of a method of wireless communication. The method may be performed by a base station or a component of a base station (e.g., the base station 102/180; the apparatus 2402; the baseband unit 2404, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to switch between transmission modes based on a link quality between a UE and a serving TRP.

At 2302, the base station may measure at least one reference signal. For example, 2302 may be performed by reference signal component 2440 of apparatus 2402. The base station may measure the at least one reference signal received from a UE. The base station may measure the at least one reference signal to determine a link quality between the UE and a serving TRP.

At 2305, the base station may switch between transmission mode states. For example, at 2304, the base station may transmit a state transition indication. For example, 2304 may be performed by indication component 2442 of apparatus 2402. The base station may transmit the state transition indication if the link quality between the UE and the serving TRP falls below a threshold. The state transition indication may enable a state transition of a transmission mode. In some aspects, the feedback may comprise CSI. The state transition indication may comprise one or more feedback bit that indicates feedback for the state transition of the transmission mode. In some aspects, a single feedback bit may indicate a request for the state transition between a single TRP operation and an mTRP operation. In some aspects, a plurality of feedback bits may indicate a request for the state transition between the single TRP operation and a plurality of modes of mTRP operations. In some aspects, the state transition of the transmission mode is a first state transition and a second state transition after the first state transition may be based on a timer. The second state transition may occur upon expiration of the timer. The timer may be based on at least one of a number of slots, a number of transmissions, or a number of ACK/NACK received by the base station.

As another example, at 2306, the base station may switch from a single TRP operation and an mTRP operation for wireless communication with the UE. For example, 2306 may be performed by switch component 2444 of apparatus 2402. The base station may switch from the single TRP operation and the mTRP operation for wireless communication with the UE after transmission of the state transition indication.

At 2308, the base station may switch between two of a sidelink transmission configuration, a Uu transmission configuration, or a sidelink and Uu transmission configuration. For example, 2308 may be performed by switch component 2444 of apparatus 2402. The base station may switch between two of the sidelink transmission configuration, the Uu transmission configuration, or the sidelink and Uu transmission configuration after transmission of the state transition indication. The state transition indication may comprise one or more feedback bits to enable the state transition of the transmission mode. In some aspects, the state transition indication may comprise at least one bit that corresponds to a respective state of the transmission mode. In some aspects, the state feedback indication may comprise at least one bit or may comprise a sequence of waveforms.

In some aspects, the base station may transmit a request to report a current state of the transmission mode. The base station may transmit the request to report the current state of the transmission mode to the UE. In some aspects, the base station may receive an indication comprising the current state of the transmission mode. The base station may receive the indication comprising the current state of the transmission mode from the UE. The UE may transmit the indication comprising the current state of the transmission mode in response to receipt of the request to report the current state of the transmission mode.

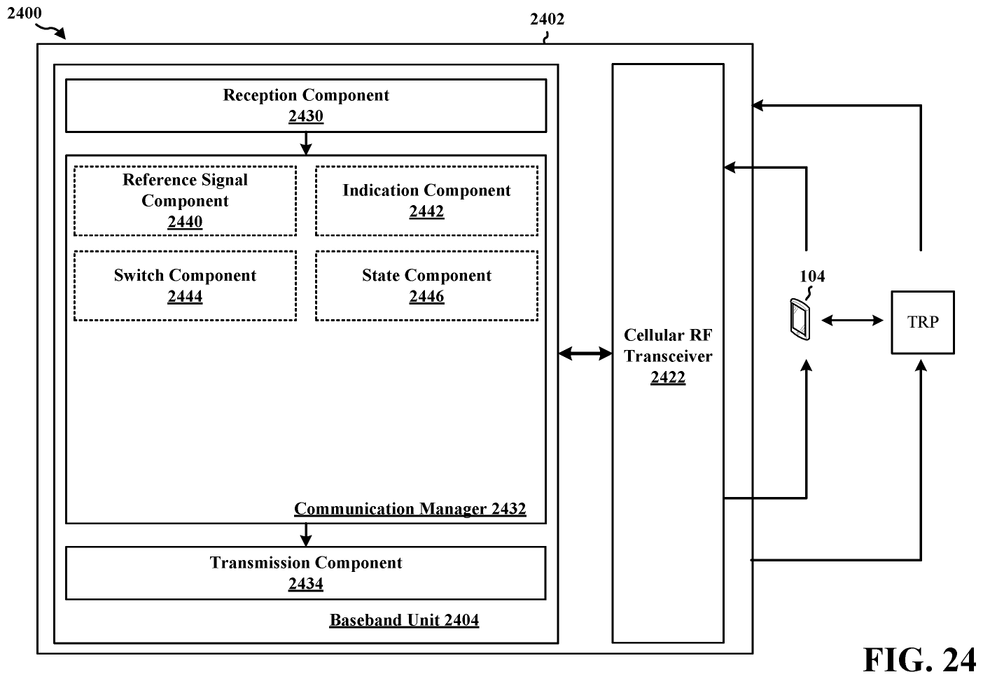

FIG. 24 is a diagram 2400 illustrating an example of a hardware implementation for an apparatus 2402. The apparatus 2402 may be a base station, a component of a base station, or may implement base station functionality. In some aspects, the apparatus 2402 may include a baseband unit 2404. The baseband unit 2404 may communicate through a cellular RF transceiver 2422 with the UE 104. The baseband unit 2404 may include a computer-readable medium/memory. The baseband unit 2404 is responsible for general processing, including the execution of software stored on the computer-readable medium/memory. The software, when executed by the baseband unit 2404, causes the baseband unit 2404 to perform the various functions described supra. The computer-readable medium/memory may also be used for storing data that is manipulated by the baseband unit 2404 when executing software. The baseband unit 2404 further includes a reception component 2430, a communication manager 2432, and a transmission component 2434. The communication manager 2432 includes the one or more illustrated components. The components within the communication manager 2432 may be stored in the computer-readable medium/memory and/or configured as hardware within the baseband unit 2404. The baseband unit 2404 may be a component of the base station 310 and may include the memory 376 and/or at least one of the TX processor 316, the RX processor 370, and the controller/processor 375.

The communication manager 2432 includes a reference signal component 2440 that may transmit at least one reference signal to a UE, e.g., as described in connection with 2002 of FIG. 20 or 2102 of FIG. 21. The reference signal component 2440 may be configured to measure at least one reference signal, e.g., as described in connection with 2202 of FIG. 22 or 2302 of FIG. 23. The communication manager 2432 further includes an indication component 2442 that may receive feedback including a state transition indication, e.g., as described in connection with 2004 of FIG. 20 or 2104 of FIG. 21. The indication component 2442 may be configured to transmit a state transition indication, e.g., as described in connection with 2204 of FIG. 22 or 2304 of FIG. 23. The communication manager 2432 further includes a switch component 2444 that may switch from a single TRP operation and an mTRP operation for wireless communication with the UE, e.g., as described in connection with 2306 of FIG. 23. The switch component 2444 may be configured to switch between two of a sidelink transmission configuration, a Uu transmission configuration, or a sidelink and Uu transmission configuration, e.g., as described in connection with 2308 of FIG. 23.

The apparatus may include additional components that perform each of the blocks of the algorithm in the flowcharts of FIGS. 20-23. As such, each block in the flowcharts of FIGS. 20-23 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2402 may include a variety of components configured for various functions. In one configuration, the apparatus 2402, and in particular the baseband unit 2404, includes means for transmitting, via a TRP associated with the base station, at least one reference signal to a UE. The apparatus includes means for receiving, from the UE, feedback including a state transition indication if a link quality between the UE and the TRP serving the UE falls below a threshold. The feedback signal enables a state transition of a transmission mode. The apparatus includes means for measuring at least one reference signal, received from a UE, to determine a link quality between the UE and a serving TRP. The apparatus includes means for transmitting, to the UE via the serving TRP, a state transition indication if the link quality between the UE and the serving TRP falls below a threshold. The state transition indication enables a state transition of a transmission mode. The apparatus further includes means for switching from a single TRP operation and an mTRP operation for wireless communication with the UE after reception of the state transition indication. The base station transmits or receives wireless communication with multiple serving TRPs in the mTRP operation. The apparatus further includes means for switching from a single TRP operation and an mTRP operation for wireless communication with the UE after transmission of the state transition indication. The apparatus further includes means for switching between two of a sidelink transmission configuration, a Uu transmission configuration, or a sidelink and Uu transmission configuration after reception of the state transition indication. The apparatus further includes means for switching between two of a sidelink transmission configuration, a Uu transmission configuration, or a sidelink and Uu transmission configuration after transmission of the state transition indication. The apparatus further includes means for transmitting, to the UE, a request to report a current state of the transmission mode. The apparatus further includes means for receiving, from the UE, an indication comprising the current state of the transmission mode of the UE in response to the request. The means may be one or more of the components of the apparatus 2402 configured to perform the functions recited by the means. As described supra, the apparatus 2402 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to measure at least one reference signal from a serving TRP to determine a link quality between the UE and the serving TRP; and transmit feedback including a state transition indication if the link quality between the UE and the serving TRP falls below a threshold, wherein the feedback enables a state transition of a transmission mode.

Aspect 2 is the apparatus of aspect 1, further includes a transceiver coupled to the at least one processor.

Aspect 3 is the apparatus of any of aspects 1 and 2, further includes that the at least one processor is further configured to switch from a single TRP operation and a multi-TRP (mTRP) operation for wireless communication with a base station after transmission of the state transition indication, wherein the UE transmits or receives wireless communication with multiple serving TRPs in the mTRP operation.

Aspect 4 is the apparatus of any of aspects 1-3, further includes that the feedback comprises CSI, wherein the state transition indication comprises one or more feedback bit that indicates feedback for the state transition of the transmission mode.

Aspect 5 is the apparatus of any of aspects 1-4, further includes that a single feedback bit indicates a request for the state transition between a single TRP operation and an mTRP operation, wherein a plurality of feedback bits indicates a request for the state transition between a single TRP operation and a plurality of modes of mTRP operations.

Aspect 6 is the apparatus of any of aspects 1-5, further includes that the at least one processor is further configured to receive a request to report a current state of the transmission mode; and transmit an indication comprising the current state of the transmission mode in response to the request.

Aspect 7 is the apparatus of any of aspects 1-6, further includes that the state transition of the transmission mode is a first state transition and a second state transition after the first state transition is based on a timer, wherein the second state transition occurs upon expiration of the timer, wherein the timer is based on at least one of a number of slots, a number of transmissions, or a number of ACK/NACK transmitted by the UE.

Aspect 8 is the apparatus of any of aspects 1-7, further includes that the at least one processor is further configured to switch between two of a sidelink transmission configuration, a Uu transmission configuration, or a sidelink and Uu transmission configuration after transmission of the state transition indication.

Aspect 9 is the apparatus of any of aspects 1-8, further includes that the feedback comprises CSI, wherein the state transition indication comprises one or more feedback bits to enable the state transition of the transmission mode.

Aspect 10 is the apparatus of any of aspects 1-9, further includes that the state transition indication comprises at least one bit that corresponds to a respective state of the transmission mode.

Aspect 11 is the apparatus of any of aspects 1-10, further includes that the state transition indication comprises at least one bit or comprises a sequence of waveforms.

Aspect 12 is a method of wireless communication for implementing any of aspects 1 to 1-11.

Aspect 13 is an apparatus for wireless communication including means for implementing any of aspects 1-11.

Aspect 14 is a computer-readable medium storing computer executable code, where the code when executed by a processor causes the processor to implement any of aspects 1-11.

Aspect 15 is an apparatus for wireless communication at a UE including at least one processor coupled to a memory and configure to transmit, to a TRP associated with a base station, at least one reference signal; and receive, from the TRP associated with the base station, a state transition indication if a link quality between the UE and the TRP serving the UE falls below a threshold, wherein the state transition indication enables a state transition of a transmission mode.

Aspect 16 is the apparatus of aspect 15, further includes a transceiver coupled to the at least one processor.

Aspect 17 is the apparatus of any of aspects 15 and 16, further includes that the at least one processor is further configured to switch from a single TRP operation and a mTRP operation for wireless communication with the base station based on receipt of the state transition indication.

Aspect 18 is the apparatus of any of aspects 15- 17, further includes that the at least one processor is further configured to switch between two of a sidelink transmission configuration, a Uu transmission configuration, or a sidelink and Uu transmission configuration after receipt of the state transition indication.

Aspect 19 is a method of wireless communication for implementing any of aspects 15-18.

Aspect 20 is an apparatus for wireless communication including means for implementing any of aspects 15-18.

Aspect 21 is a computer-readable medium storing computer executable code, where the code when executed by a processor causes the processor to implement any of aspects 15-18.

Aspect 22 is an apparatus for wireless communication at a base station including at least one processor coupled to a memory and configured to transmit, via a TRP associated with the base station, at least one reference signal to a UE; and receive, from the UE, feedback including a state transition indication if a link quality between the UE and the TRP serving the UE falls below a threshold, wherein the feedback enables a state transition of a transmission mode.

Aspect 23 is the apparatus of aspect 22, further includes a transceiver coupled to the at least one processor.

Aspect 24 is the apparatus of any of aspects 22 and 23, further includes that the at least one processor is further configured to switch from a single TRP operation and an mTRP operation for wireless communication with the UE after reception of the state transition indication, wherein the base station transmits or receives wireless communication with multiple serving TRPs in the mTRP operation.

Aspect 25 is the apparatus of any of aspects 22-24, further includes that the feedback comprises CSI, wherein the state transition indication comprises one or more feedback bit that indicates feedback for the state transition of the transmission mode.

Aspect 26 is the apparatus of any of aspects 22-25, further includes that a single feedback bit indicates a request for the state transition between a single TRP operation and an mTRP operation, wherein a plurality of feedback bits indicates a request for the state transition between a single TRP operation and a plurality of modes of mTRP operations.

Aspect 27 is the apparatus of any of aspects 22-26, further includes that the at least one processor is further configured to transmit, to the UE, a request to report a current state of the transmission mode; and receive, from the UE, an indication comprising the current state of the transmission mode of the UE in response to the request.

Aspect 28 is the apparatus of any of aspects 22-27, further includes that the state transition of the transmission mode is a first state transition and a second state transition after the first state transition is based on a timer, wherein the second state transition occurs upon expiration of the timer, wherein the timer is based on at least one of a number of slots, a number of transmissions, or a number of ACK/NACK received by the base station.

Aspect 29 is the apparatus of any of aspects 22-28, further includes that the at least one processor is further configured to switch between two of a sidelink transmission configuration, a Uu transmission configuration, or a sidelink and Uu transmission configuration after reception of the state transition indication.

Aspect 30 is the apparatus of any of aspects 22-29, further includes that the feedback comprises CSI, wherein the state transition indication comprises one or more feedback bits to enable the state transition of the transmission mode.

Aspect 31 is the apparatus of any of aspects 22-30, further includes that the state transition indication comprises at least one bit that corresponds to a respective state of the transmission mode.

Aspect 32 is the apparatus of any of aspects 22-31, further includes that the state transition indication comprises at least one bit or comprises a sequence of waveforms.

Aspect 33 is a method of wireless communication for implementing any of aspects 22-32.

Aspect 34 is an apparatus for wireless communication including means for implementing any of aspects 22-32.

Aspect 35 is a computer-readable medium storing computer executable code, where the code when executed by a processor causes the processor to implement any of aspects 22-32.

Aspect 36 is an apparatus for wireless communication at a base station including at least one processor coupled to a memory and configured to measure at least one reference signal, received from a UE, to determine a link quality between the UE and a serving TRP; and transmit, to the UE via the serving TRP, a state transition indication if the link quality between the UE and the serving TRP falls below a threshold, wherein the state transition indication enables a state transition of a transmission mode.

Aspect 37 is the apparatus of aspect 36, further includes a transceiver coupled to the at least one processor.

Aspect 38 is the apparatus of any of aspects 36 and 37, further includes that the at least one processor is further configured to switch from a single TRP operation and an mTRP operation for wireless communication with the UE after transmission of the state transition indication.

Aspect 39 is the apparatus for any of aspects 36-38, further includes that the at least one processor is further configured to switch between two of a sidelink transmission configuration, a Uu transmission configuration, or a sidelink and Uu transmission configuration after transmission of the state transition indication.

Aspect 40 is a method of wireless communication for implementing any of aspects 36-39.

Aspect 41 is an apparatus for wireless communication including means for implementing any of aspects 36-39.

Aspect 42 is a computer-readable medium storing computer executable code, where the code when executed by a processor causes the processor to implement any of aspects 36-39.

What is claimed is:

1. An apparatus for wireless communication at a user equipment (UE), comprising:
a memory; and
at least one processor coupled to the memory and configured to:
measure at least one reference signal from a serving transmission reception point (TRP) to determine a link quality between the UE and the serving TRP; and
transmit feedback including a state transition indication if the link quality between the UE and the serving TRP falls below a threshold, wherein the feedback enables a state transition of a transmission mode.

2. The apparatus of claim 1, further comprising a transceiver coupled to the at least one processor.

3. The apparatus of claim 1, wherein the at least one processor is further configured to:
switch from a single TRP operation and a multi-TRP (mTRP) operation for wireless communication with a base station after transmission of the state transition indication, wherein the UE transmits or receives wireless communication with multiple serving TRPs in the mTRP operation.

4. The apparatus of claim 1, wherein the feedback comprises channel state information (CSI), wherein the state transition indication comprises one or more feedback bit that indicates feedback for the state transition of the transmission mode.

5. The apparatus of claim 4, wherein a single feedback bit indicates a request for the state transition between a single TRP operation and a multi-TRP (mTRP) operation, wherein a plurality of feedback bits indicates a request for the state transition between a single TRP operation and a plurality of modes of mTRP operations.

6. The apparatus of claim 4, wherein the at least one processor is further configured to:
receive a request to report a current state of the transmission mode; and
transmit an indication comprising the current state of the transmission mode in response to the request.

7. The apparatus of claim 1, wherein the state transition of the transmission mode is a first state transition and a second state transition after the first state transition is based on a timer, wherein the second state transition occurs upon expiration of the timer, wherein the timer is based on at least one of a number of slots, a number of transmissions, or a number of acknowledgement (ACK)/negative acknowledgement (NACK) transmitted by the UE.

8. The apparatus of claim 1, wherein the at least one processor is further configured to:
switch between two of a sidelink transmission configuration, a Uu transmission configuration, or a sidelink and Uu transmission configuration after transmission of the state transition indication.

9. The apparatus of claim 8, wherein the feedback comprises channel state information (CSI), wherein the state transition indication comprises one or more feedback bits to enable the state transition of the transmission mode.

10. The apparatus of claim 8, wherein the state transition indication comprises at least one bit that corresponds to a respective state of the transmission mode.

11. The apparatus of claim 8, wherein the state transition indication comprises at least one bit or comprises a sequence of waveforms.

12. An apparatus for wireless communication at a user equipment (UE), comprising:
a memory; and
at least one processor coupled to the memory and configured to:
transmit, to a transmission reception point (TRP) associated with a base station, at least one reference signal; and
receive, from the TRP associated with the base station, a state transition indication if a link quality between the UE and the TRP serving the UE falls below a threshold, wherein the state transition indication enables a state transition of a transmission mode.

13. The apparatus of claim 12, further comprising a transceiver coupled to the at least one processor.

14. The apparatus of claim 12, wherein the at least one processor is further configured to:
switch from a single TRP operation and a multi-TRP (mTRP) operation for wireless communication with the base station based on receipt of the state transition indication.

15. The apparatus of claim 12, wherein the at least one processor is further configured to:
switch between two of a sidelink transmission configuration, a Uu transmission configuration, or a sidelink and Uu transmission configuration after receipt of the state transition indication.

16. An apparatus for wireless communication at a base station, comprising:
a memory; and
at least one processor coupled to the memory and configured to:
transmit, via a transmission reception point (TRP) associated with the base station, at least one reference signal to a user equipment (UE); and
receive, from the UE, feedback including a state transition indication if a link quality between the UE and the TRP serving the UE falls below a threshold, wherein the feedback enables a state transition of a transmission mode.

17. The apparatus of claim 16, further comprising a transceiver coupled to the at least one processor.

18. The apparatus of claim 16, wherein the at least one processor is further configured to:
switch from a single TRP operation and a multi-TRP (mTRP) operation for wireless communication with the UE after reception of the state transition indication, wherein the base station transmits or receives wireless communication with multiple serving TRPs in the mTRP operation.

19. The apparatus of claim 16, wherein the feedback comprises channel state information (CSI), wherein the state transition indication comprises one or more feedback bit that indicates feedback for the state transition of the transmission mode.

20. The apparatus of claim 19, wherein a single feedback bit indicates a request for the state transition between a single TRP operation and a multi-TRP (mTRP) operation, wherein a plurality of feedback bits indicates a request for the state transition between a single TRP operation and a plurality of modes of mTRP operations.

21. The apparatus of claim 19, wherein the at least one processor is further configured to:
transmit, to the UE, a request to report a current state of the transmission mode; and
receive, from the UE, an indication comprising the current state of the transmission mode of the UE in response to the request.

22. The apparatus of claim 16, wherein the state transition of the transmission mode is a first state transition and a second state transition after the first state transition is based on a timer, wherein the second state transition occurs upon expiration of the timer, wherein the timer is based on at least one of a number of slots, a number of transmissions, or a number of acknowledgement (ACK)/negative acknowledgement (NACK) received by the base station.

23. The apparatus of claim 16, wherein the at least one processor is further configured to:
switch between two of a sidelink transmission configuration, a Uu transmission configuration, or a sidelink and Uu transmission configuration after reception of the state transition indication.

24. The apparatus of claim 23, wherein the feedback comprises channel state information (CSI), wherein the state transition indication comprises one or more feedback bits to enable the state transition of the transmission mode.

25. The apparatus of claim 23, wherein the state transition indication comprises at least one bit that corresponds to a respective state of the transmission mode.

26. The apparatus of claim 23, wherein the state transition indication comprises at least one bit or comprises a sequence of waveforms.

27. An apparatus for wireless communication at a base station, comprising:
a memory; and
at least one processor coupled to the memory and configured to:
measure at least one reference signal, received from a user equipment (UE), to determine a link quality between the UE and a serving transmission reception point (TRP); and
transmit, to the UE via the serving TRP, a state transition indication if the link quality between the UE and the serving TRP falls below a threshold, wherein the state transition indication enables a state transition of a transmission mode.

28. The apparatus of claim 27, further comprising a transceiver coupled to the at least one processor.

29. The apparatus of claim 27, wherein the at least one processor is further configured to:
switch from a single TRP operation and a multi-TRP (mTRP) operation for wireless communication with the UE after transmission of the state transition indication.

30. The apparatus of claim 27, wherein the at least one processor is further configured to:
switch between two of a sidelink transmission configuration, a Uu transmission configuration, or a sidelink and Uu transmission configuration after transmission of the state transition indication.
